(19) United States
(12) Patent Application Publication
(10) Pub. No.: US 2020/0207187 A1
(43) Pub. Date: Jul. 2, 2020

(54) VARIABLE TRANSMITTANCE VEHICLE WINDOW

(71) Applicant: Switch Materials Inc., Burnaby (CA)

(72) Inventors: Matthew P. Smit, Burnaby (CA); Duhane Lam, Vancouver (CA); Glen R. Bremner, New Westminster (CA); Jonathan R. Sargent, Whistler (CA); Jeremy G. Finden, North Vancouver (CA); Douglas M. Wiggin, Burnaby (CA); Broderick W. Albright, Burnaby (CA)

(21) Appl. No.: 16/490,215

(22) PCT Filed: Feb. 27, 2018
(86) PCT No.: PCT/CA2018/050227

§ 371 Date: Aug. 30, 2019

Related U.S. Application Data
(60) Provisional application No. 62/465,530, filed on Mar. 1, 2017.

(51) Int. Cl. B60J 3/04; G02F 1/153; G02F 1/155; G02F 1/163

(52) U.S. Cl. CPC B60J 3/04; G02F 1/163; G02F 1/155; G02F 1/1533

(57) ABSTRACT

A variable transmittance vehicle window may adjust its transmittance in response to readings from an interior light sensor that is positioned to measure intensity of at least one wavelength of light that is a proper subset of the visible spectrum and that has entered the interior of a vehicle comprising the window after passing through the window. If the intensity of light inside the vehicle is too high, the window is darkened; analogously, if the intensity of light inside the vehicle is too low, the window is lightened. Additionally or alternatively, the window may be transitioned to and maintained at an intermediate transmittance that is between the window's maximum and minimum transmittances.

### TECHNICAL FIELD

The present disclosure is directed at a variable transmittance vehicle window.

### BACKGROUND

Variable transmittance optical filters can be incorporated into a window to manufacture a variable transmittance window that permits the electromagnetic radiation that is transmitted through the window to be selectively filtered. For example, when incorporated into a vehicle, such as the vehicle's sunroof or passenger windows, one or both of the intensity and frequency of the electromagnetic radiation that enters and exits the vehicle via variable transmittance windows can be controlled to influence parameters such as the intensity of light within the vehicle.

### SUMMARY

According to a first aspect, there is provided a variable transmittance vehicle window. The window comprises a non-opaque substrate; a switching material affixed to the substrate and positioned such that at least some light that passes through the substrate also passes through the switching material; a first electrode and a second electrode electrically coupled to the switching material, wherein transmittance of the switching material decreases until reaching a minimum on exposure to a first stimulus and increases until reaching a maximum in response to application of a second stimulus, wherein at least one of the first and second stimuli comprises applying a voltage across the electrodes; voltage application circuitry for selectively applying different voltages across the electrodes; an interior light sensor positioned to measure intensity of at least one wavelength of light that has entered the interior of a vehicle comprising the window after passing through the substrate and the switching material, wherein the at least one wavelength of light is a proper subset of the visible spectrum; and a computer readable medium and a processor communicatively coupled to the computer readable medium, the interior light sensor, and the switching circuitry. The computer readable medium has encoded thereon program code, executable by the processor, which when executed by the processor causes the processor to obtain an intensity measurement from the interior light sensor of the at least one wavelength of light; and in response to the intensity measurement, increase or decrease the absolute value of the voltage applied across the electrodes such that the transmittance of the switching material is increased or decreased.

The at least one wavelength of light may comprise a range of wavelengths, and the intensity measurement of the range of wavelengths may be a cumulative intensity of the range of wavelengths.

The range of wavelengths may be continuous.

The range of wavelengths may comprise less than approximately 10% of the visible light spectrum, less than approximately 20% of the visible light spectrum, less than approximately 30% of the visible light spectrum, less than approximately 40% of the visible light spectrum, less than approximately 50% of the visible light spectrum, less than approximately 60% of the visible light spectrum, less than approximately 70% of the visible light spectrum, less than approximately 80% of the visible light spectrum, or less than approximately 90% of the visible light spectrum.

The at least one wavelength of light may comprise at least two different wavelengths, and the processor may obtain an intensity measurement for each of the at least two different wavelengths. The processor may also determine an effective color resulting from a combination of the at least two different wavelengths; determine whether the effective color comprises part of an undesirable color zone that is a proper subset of a color space comprising the at least two different wavelengths; and increase or decrease the absolute value of the voltage in response to whether the effective color comprises part of the undesirable color zone.

The effective color may be outside of the undesirable color zone, and the processor may consequently increase the voltage to lighten the switching material.

The effective color may be within the undesirable color zone, and the processor may consequently decrease the voltage to darken the switching material.

The at least two different wavelengths may be wavelengths corresponding to blue light and green light.

The window may further comprise a temperature sensor communicatively coupled to the processor and positioned to measure an operating temperature of the switching material, and the processor may determine whether the effective color is within the undesirable color zone using the operating temperature.

The window may further comprise an exterior light sensor communicatively coupled to the processor and positioned to measure the intensity of the at least one wavelength of light that has not passed through the switching material, and the processor may determine what percentage of the at least one wavelength of light is transmitted through the substrate and the switching material; and use the percentage of the at least one wavelength of light that is transmitted through the substrate and the switching material to determine the effective color.

The processor may increase the absolute value of the voltage to increase the transmittance of the switching material and decrease the absolute value of the voltage to decrease the transmittance of the switching material.

According to another aspect, there is provided a variable transmittance vehicle window that comprises a non-opaque substrate; a switching material affixed to the substrate and positioned such that at least some light that passes through the substrate also passes through the switching material; a first electrode and a second electrode electrically coupled to the switching material, wherein transmittance of the switching material decreases until reaching a minimum on exposure to a first stimulus and increases until reaching a maximum in response to application of a second stimulus, wherein at least one of the first and second stimuli comprises applying a voltage across the electrodes; voltage application circuitry for selectively applying different voltages across the electrodes; and a computer readable medium and a processor communicatively coupled to the computer readable medium and the voltage application circuitry. The computer readable medium may have encoded on it program code, executable by the processor, which when executed by the processor causes the processor to transition the switching material from a first transmittance to an intermediate transmittance that is between a maximum and minimum transmittance of the switching material; and maintain the switching material at approximately the intermediate transmittance for a time period.

The first transmittance may be the maximum or minimum transmittance of the switching material.

The processor may apply a pulse width modulated signal having a duty cycle of less than 100% to transition the switching material to and maintain the switching material at the intermediate transmittance.

The processor may apply a pulse width modulated signal that transitions between a non-zero peak voltage when on and a non-zero off voltage when off.

The processor may apply a first pulse width modulated signal to transition the switching material to the intermediate state and a second pulse width modulated signal to maintain the switching material at the intermediate state, with the first pulse width modulated signal having a duty cycle higher than that of the second pulse width modulated signal.

The window may further comprise an interior light sensor positioned to measure intensity of at least one wavelength of light that has entered the interior of a vehicle comprising the window after passing through the substrate and the switching material, and the program code may further cause the processor to obtain an intensity measurement from the interior light sensor of the at least one wavelength of light; and when the intensity of the at least one wavelength of light exceeds an upper intensity threshold, transition the switching material to a darker intermediate state and maintain the switching material at the darker intermediate state.

When the intensity of the at least one wavelength of light is below a lower intensity threshold, the processor may transition the switching material to a lighter intermediate state and maintain the switching material at the lighter intermediate state.

During the time period, the transmittance of the switching material may be maintained at within 50% of the intermediate transmittance, 40% of the intermediate transmittance, 30% of the intermediate transmittance, 20% of the intermediate transmittance, or 10% of the intermediate transmittance.

According to another aspect, there is provided a method for varying transmittance of a variable transmittance vehicle window comprising a switching material, the method comprising obtaining, on an interior of a vehicle comprising the window, an intensity measurement of at least one wavelength of light that has passed through the window, wherein the at least one wavelength of light is a proper subset of the visible spectrum; and in response to the intensity measurement, increasing or decreasing the absolute value of the voltage applied across the electrodes such that the transmittance of the switching material is increased or decreased.

The at least one wavelength of light may comprise a range of wavelengths, and the intensity measurement of the range of wavelengths may be a cumulative intensity of the range of wavelengths.

The range of wavelengths may be continuous.

The range of wavelengths may comprise less than approximately 10% of the visible light spectrum, less than approximately 20% of the visible light spectrum, less than approximately 30% of the visible light spectrum, less than approximately 40% of the visible light spectrum, less than approximately 50% of the visible light spectrum, less than approximately 60% of the visible light spectrum, less than approximately 70% of the visible light spectrum, less than approximately 80% of the visible light spectrum, or less than approximately 90% of the visible light spectrum.

The at least one wavelength of light may comprise at least two different wavelengths, and the intensity measurement may be for each of the at least two different wavelengths. The method may further comprise determining an effective color resulting from a combination of the at least two different wavelengths; determining whether the effective color comprises part of an undesirable color zone that is a proper subset of a color space comprising the at least two different wavelengths; and increasing or decreasing the absolute value of the voltage in response to whether the effective color comprises part of the undesirable color zone.

When the effective color is outside of the undesirable color zone, the voltage may be increased to lighten the switching material.

When the effective color is within the undesirable color zone, the voltage may be decreased to darken the switching material.

The at least two different wavelengths may be wavelengths corresponding to blue light and green light.

The method may further comprise measuring an operating temperature of the switching material, and determining whether the effective color is within the undesirable color zone using the operating temperature.

The method may further comprise measuring the intensity of the at least one wavelength of light that has not passed through the switching material; determining what percentage of the at least one wavelength of light is transmitted through the substrate and the switching material; and using the percentage of the at least one wavelength of light that is transmitted through the substrate and the switching material to determine the effective color.

The absolute value of the voltage may be increased to increase the transmittance of the switching material and the absolute value of the voltage may be decreased to decrease the transmittance of the switching material.

Accordant to another aspect, there is provided a method for varying transmittance of a variable transmittance vehicle window comprising a switching material the method comprising transitioning the switching material from a first transmittance to an intermediate transmittance that is between a maximum and minimum transmittance of the switching material; and maintaining the switching material at approximately the intermediate transmittance for a time period.

The first transmittance may be the maximum or minimum transmittance of the switching material.

A pulse width modulated signal having a duty cycle of less than 100% may be applied to transition the switching material to and maintain the switching material at the intermediate transmittance.

A pulse width modulated signal may transition between a non-zero peak voltage when on and a non-zero off voltage when off is applied to the switching material.

A first pulse width modulated signal may be applied to the switching material to transition the switching material to the intermediate state and a second pulse width modulated signal is applied to the switching material to maintain the switching material at the intermediate state, with the first pulse width modulated signal having a duty cycle higher than that of the second pulse width modulated signal.

The method may further comprise obtaining an intensity measurement from the interior light sensor of the at least one wavelength of light; and when the intensity of the at least one wavelength of light exceeds an upper intensity threshold, transitioning the switching material to a darker intermediate state and maintain the switching material at the darker intermediate state.

When the intensity of the at least one wavelength of light is below a lower intensity threshold, the method may further comprise transitioning the switching material to a lighter intermediate state and maintaining the switching material at the lighter intermediate state.

During the time period, the transmittance of the switching material may be maintained at within 50% of the intermediate transmittance, 40% of the intermediate transmittance, 30% of the intermediate transmittance, 20% of the intermediate transmittance, or 10% of the intermediate transmittance.

Additional aspects comprise combinations of the foregoing. For example, certain aspects are directed at transitioning the window to and maintaining the window at an intermediate state while also using intensity measurements from one or both of the interior and exterior sensors to adjust transmittance of the window.

According to another aspect, there is provided a non-transitory computer readable medium having stored thereon program code that is executable by a processor and that, when executed by the processor, causes the processor to perform any of the foregoing aspects of the method or suitable combinations thereof.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 is a block diagram of one embodiment of a variable transmittance window assembly.

FIG. 2 is a diagram depicting positioning of light sensors relative to an optical filter assembly and a light source in the embodiment of the window assembly of FIG. 1.

FIG. 3 depicts example calibration curves of the light sensors for an example type of red, green, and blue sensor used in the embodiment of the window assembly of FIG. 1.

FIG. 4 compares intensities of red, green, and blue wavelengths of light as measured using the type of light sensor used in the embodiment of the window assembly of FIG. 1 versus a spectrophotometer.

FIG. 5 shows an example undesirable color zone used in the embodiment of the window assembly of FIG. 1, with the undesirable color zone comprising a subset of a red, green, and blue color space.

FIGS. 6A and 6B show plots of the intensities of red, green, and blue wavelengths of light in relation to undesirable color areas derived from the undesirable color zone of FIG. 5, with the plots being used to determine whether to fade or darken the window assembly of FIG. 1.

FIG. 7 shows plots of intensities of blue and green wavelengths of light in relation to an undesirable color area according to another embodiment, with the plots being used to determine whether to fade or darken the window assembly of FIG. 1.

FIG. 8A shows a system comprising the optical filter assembly and a user adjustable dial that controls transmittance of the assembly, according to another embodiment.

FIG. 8B illustrates how the dial of FIG. 8A affects the duty cycle of a control signal applied to the assembly.

FIG. 8C shows the system of FIG. 8A augmented with a photodiode, according to another embodiment.

FIG. 9 shows a model current-time profile for the optical filter assembly, according to another embodiment.

FIG. 10 shows a graph of measured voltage for the oxidation of a chromophore according to another embodiment during accelerated durability testing.

FIG. 11 shows a system for performing cyclic voltammetry on the optical filter assembly, according to another embodiment.

FIG. 12 shows a plot of current through vs. voltage across the optical filter assembly obtained using the system of FIG. 11.

FIG. 13 shows a representative linear sweep voltammogram of a film comprising part of the optical filter assembly, according to another embodiment.

FIG. 14 shows a plot evidencing the effect of overvoltages on light and dark state of the optical filter assembly during electrical durability testing, according to another embodiment.

FIG. 15 shows a plot of voltage vs. time comparing step vs. ramp voltages that are applied across the optical filter assembly, according to another embodiment.

FIG. 16 shows the current response of the optical filter assembly to the voltages of FIG. 15.

FIG. 17 is a graph of results of a cyclic voltammogram of the optical filter assembly, according to another example embodiment.

FIG. 18 shows transmission spectra for the optical filter assembly tested in

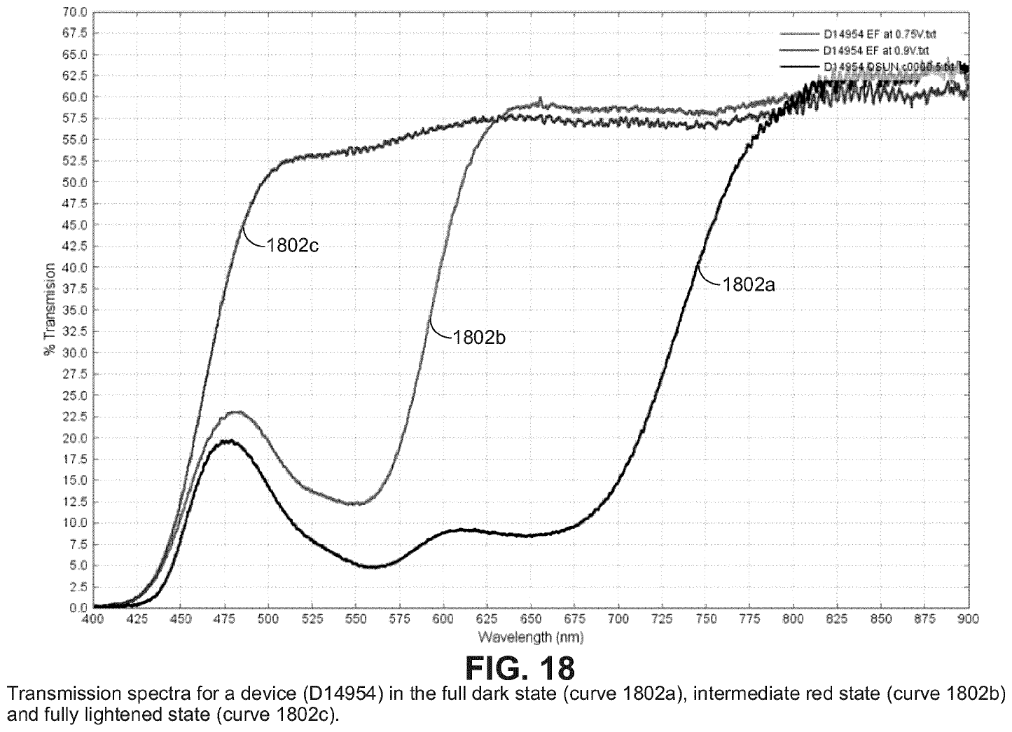

FIG. 17.

FIG. 19 shows spectra of various embodiments of the optical assembly comparing transmittance in a dark state and transmittance after experiencing spontaneous fading.

### DETAILED DESCRIPTION

In the present disclosure, unless the context clearly indicates otherwise:
(a) Directional terms such as “top”, “bottom”, “upwards”, “downwards”, “vertically”, and “laterally” are used for the purpose of providing relative reference only, and are not intended to suggest any limitations on how any article is to be positioned during use, or to be mounted in an assembly or relative to an environment.
(b) The term “couple” and variants of it such as “coupled”, “couples”, and “coupling” are intended to include indirect and direct connections. For example, if a first device is coupled to a second device, that coupling may be through a direct connection or through an indirect connection via other devices and connections. Similarly, if the first device is communicatively coupled to the second device, communication may be through a direct connection or through an indirect connection via other devices and connections.
(c) The singular forms “a”, “an”, and “the” are intended to include the plural forms as well.
(d) When used in conjunction with a numerical value, the words “about” and “approximately” mean within +/−10% of that numerical value, unless the context indicates otherwise.

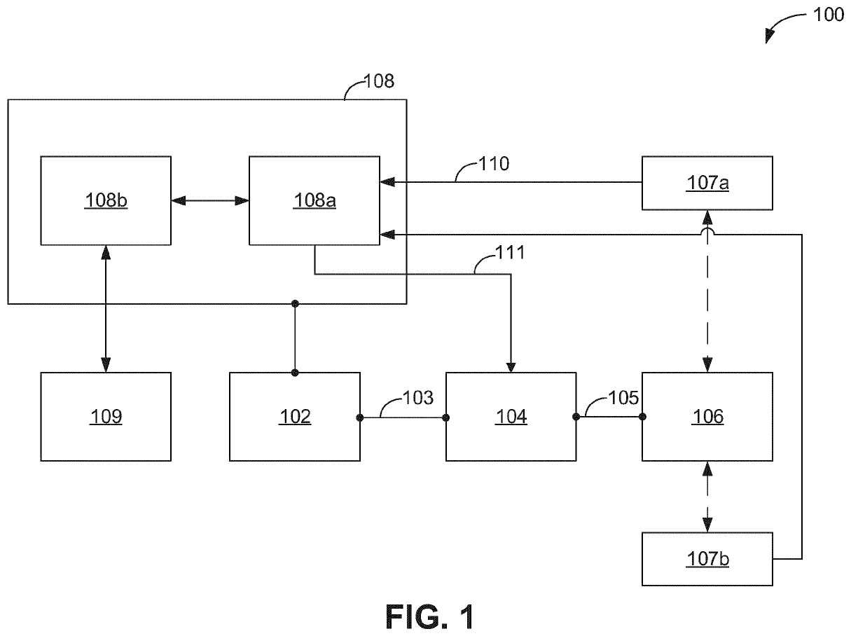

Referring to FIG. 1, there is shown one embodiment of a variable transmittance window assembly 100. The window assembly 100 comprises a controller 108 that comprises a processor 108b and an input/output module 108a (“I/O module”) that are communicatively coupled to each other. The controller 108 is electrically coupled to a power supply 102; a non-transitory computer readable medium 109 that has encoded on it program code that is executable by the controller 108; switching circuitry 104 controlled by the controller 108 via a control input 111, and which is also coupled to the power supply 102 through input voltage terminals 103 and which outputs a voltage from the power supply 102 across load terminals 105; an optical filter assembly 106 across which the load terminals 105 can apply the voltage from the power supply 102; and an interior light sensor 107a and an exterior light sensor 107b (collectively, the light sensors 107a,b are referred to as the “sensors 107”). The switching circuitry 104 may comprise, for example, an H-bridge capable of applying a forward and reverse voltage across load terminals 105, as well as open and short-circuiting the load terminals 105. The switching circuitry is one example of voltage application circuitry that is for selectively applying different voltages across the electrodes.

The assembly 106 comprises a non-opaque substrate, such as glass used in automotive windows or polymer film; a switching material affixed to the substrate and positioned such that at least some light that passes through the substrate also passes through the switching material; and a first electrode located on one side of and electrically coupled to the switching material and a second electrode located on another side of and electrically coupled to the switching material. The transmittance of the switching material decreases until reaching a minimum on exposure to sunlight and absent application across the electrodes of a voltage required to increase the transmittance, and wherein the transmittance of the switching material increases until reaching a maximum in response to application of the voltage across the electrodes. While in the depicted example embodiment the electrodes are on opposing sides of the switching material, in different embodiments (not depicted) the electrodes may be in contact with the same side of the switching material and located on the same side of the substrate. Additionally, in different embodiments the transmittance of the switching material may change in response to different stimuli. For example, the transmittance of the switching material decreases until reaching a minimum on exposure to a first stimulus and increases until reaching a maximum in response to application of a second stimulus, wherein at least one of the first and second stimuli comprises applying a voltage across the electrodes.

A polyethylene terephthalate (“PET”) film with an electrodes on it is coated with the switching material. The switching material is then covered with a second PET film with the second electrode, and the switching material, PET films, and electrodes are laminated between glass using polyvinyl butyral (“PVB”). In this embodiment, the PET film on which the switching material is coated comprises the substrate. In some different embodiments, the switching material is applied directly to the glass and a single PET film is laminated over the switching material; in additional embodiments, the switching material is laminated to the PET film and neither is affixed directly to glass.

The switching material may incorporate photochromic, electrochromic, hybrid photochromic/electrochromic, liquid crystal, or suspended particle technologies. Photochromic optical filters tend to automatically darken when exposed to sunlight, and lighten in the absence of sunlight. Electrochromic, liquid crystal, and suspended particle technologies however, tend to alternate between dark and light transmissive states in response to electricity. Electrochromic optical filters, for example, tend to darken when a voltage is applied across a pair of terminals electrically coupled to different sides of the electrochromic material, and tend to lighten when the polarity of the voltage is reversed. While in the depicted embodiment the photochromic filters are tuned to darken when exposed to sunlight, in different embodiments the photochromic filters may comprise different chromophores tuned to respond to different wavelengths. For example, some chromophores may be tuned to darken in response to non-visible light, or to only a subset of wavelengths that comprise sunlight.

The optical filter assemblies 106 used in the embodiments discussed herein are based on a hybrid photochromic/electrochromic technology, which conversely darken in response to sunlight, ultraviolet, or certain other wavelengths of electromagnetic radiation (hereinafter “light”) and lighten or become transparent (hereinafter interchangeably referred to as “fading”) in response to a non-zero voltage applied across the terminals of the optical filter assembly. Hybrid photochromic/electrochromic optical filters comprise a switching material having one or more chromophores that are reversibly convertible between colored (dark) and uncolored (faded) states; the switching material may further comprise a solvent portion, polymers, salts, or other components to support the conversion of the chromophore between colored and uncolored states when exposed to light or voltage. Some examples of chromophores comprise fulgides, diarylethenes or dithienylcyclopentenes. However, in different embodiments (not depicted), other types of optical filters comprising alternative switching materials with similar behavior to hybrid photochromic/electrochromic switching materials, may also be employed.

While the present disclosure references operative states of the assembly 106 as simply “dark”, “faded”, or “intermediate”, the optical transmittance or clarity of the assembly 106 in particular states may also vary according to specific embodiments. For example, the “dark” state in one embodiment may refer to a transmittance of approximately 5%, whereas in another embodiment the “dark” state may refer to transmittance anywhere in the range of 0% to approximately 15%. In another example, the assembly 106 may be optically clear when in the “faded” state in one embodiment and only partially transparent in another embodiment.

The window assembly 100 of FIG. 1 is operable to apply a portion of the supply voltage received at the input voltage terminals 103 across the load terminals 105 to transition the assembly 106 to a faded state, and is also capable of transitioning the assembly 106 to a dark state by open or short circuiting the load terminals 105, based on feedback received from the sensors 107. As described in more detail below, the sensors 107 output a signal 110 indicative of one or both of cumulative light intensity and intensity at each of one or more wavelengths of light, and send the signal 110 to the I/O module 108a of the controller 108.

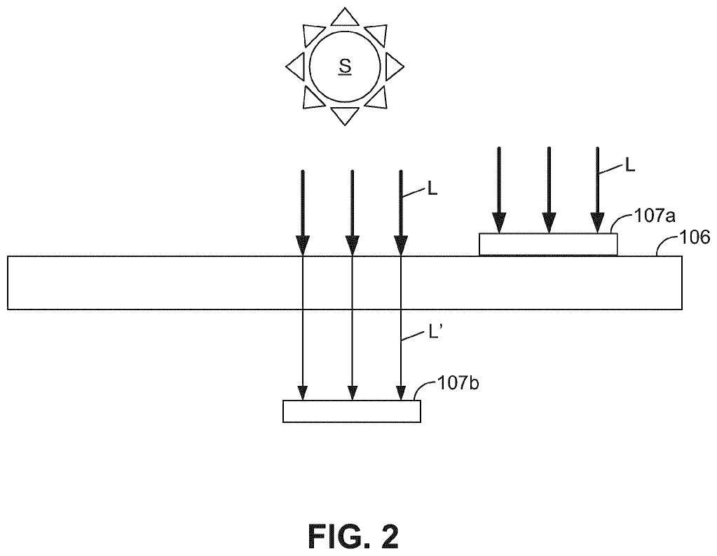

The processor 108b, through the I/O module 108a, receives and processes the signal 110 and controls the switching circuitry 104 via the control input 111 to place the assembly 106 into a desired state, as described in further detail below in respect of FIGS. 2 to 6B.

If the processor 108b determines that the assembly 106 should be in the faded state, the processor 108b, via the I/O module 108a, configures the switching circuitry 104 such that at least a portion of the voltage received from the input voltage terminals 103, sufficient to transition the filter to the faded state (a “threshold voltage”), is applied across its load terminals 105 to thereby fade the assembly 106. The magnitude of the threshold voltage to fade or transition the assembly 106 varies according to the particular switching material used, and may also be affected by extrinsic factors. In a particular embodiment, the threshold voltage is in the range of 0.6 to 2.5 V, but may also range from 0.1 to 10 V in other embodiments.

Referring now to FIG. 2, there is shown a diagram depicting positioning of the light sensors 107 relative to the optical filter assembly 106 and a light source S. In FIG. 2, the optical filter assembly 106 comprises part of a window of a vehicle, and each of the sensors 107 comprises a red, green, and blue (“RGB”) light sensor to detect the intensity of light at each of red, green, and blue wavelengths. More particularly, in the example of FIG. 2 each of the sensors 107 is configured to measure the intensity of light at each of approximately 625 nm (red light), 540 nm (green light), and 465 nm (blue light), although in different embodiments one or both of the light sensors 107 may be configured to measure the intensity at any one or more wavelengths of light, or the cumulative intensity at any one or more ranges of wavelengths of light, with each of the ranges being a proper subset of the visible light spectrum, with the visible light spectrum being light having a wavelength from approximately 380 nm to 780 nm. For example, in some embodiments the range of wavelengths may comprise less than approximately 10% of the visible light spectrum, less than approximately 20% of the visible light spectrum, less than approximately 30% of the visible light spectrum, less than approximately 40% of the visible light spectrum, less than approximately 50% of the visible light spectrum, less than approximately 60% of the visible light spectrum, less than approximately 70% of the visible light spectrum, less than approximately 80% of the visible light spectrum, or less than approximately 90% of the visible light spectrum. Additionally, in different embodiments one or both of the sensors 107 may comprise other than RGB sensors, and different wavelengths of light may accordingly be measured. For example, in one different embodiment, the sensors 107 are tuned to measure the chromophore absorption peaks of the switching material comprising the optical filter assembly 106.

The light source S emits light, of which a portion is incident on the optical filter assembly 106 from the exterior of the vehicle (that incident light is “incident light L”). At least some of the incident light L is transmitted through the optical filter assembly 106 (that transmitted light is “transmitted light L′”) to the interior of the vehicle. The exterior light sensor 107b is positioned to measure the intensity of the incident light L and the interior light sensor 107a is positioned to measure the intensity of the transmitted light L′; more particularly, in FIG. 2 the exterior sensor 107b and the interior sensor 107a respectively measure and output a signal to the controller 108 from which the controller 108 is able to determine the intensity of the incident light L and transmitted light L′ at at least one wavelength of light, and in the depicted embodiment at each of 625 nm, at 540 nm, and at 465 nm. More generally, each of the sensors 107 is able to measure intensity of at least one wavelength of light, where the at least one wavelength of light is a proper subset of the visible spectrum (i.e., a subset of and not equal to the visible spectrum). In some embodiments, the exterior sensor 107b is positioned outside of the vehicle. In different embodiments, the exterior sensor 107b is positioned inside of the vehicle; for example when the window 100 comprises a sunroof of the vehicle, the switching material may be removed from a portion of the sunroof and the exterior sensor 107b may be positioned adjacent to that portion of the sunroof so as to sense intensity of incident light that has not passed through the switching material.

The controller 108 is then able to determine the percent transmittance (% T) at each wavelength using Equations (1) to (3):

$$\begin{matrix}\% {T}_{R} = \frac{{R}_{inner}}{{R}_{outer}} & ( 1 ) \\ \% {T}_{G} = \frac{{G}_{inner}}{{G}_{outer}} & ( 2 ) \\ \% {T}_{B} = \frac{{B}_{i n n e r}}{{B}_{outer}} & ( 3 )\end{matrix}$$

where % T_{R} is the percent of red wavelength light that is transmitted through the optical filter assembly 106, Rᵢₙₙₑᵣ is the intensity of the red wavelength light as measured by the interior light sensor 107a, and Rₒᵤₜₑᵣ is the intensity of the red wavelength light as measured by the exterior light sensor 107b; % T_{G} is the percent of green wavelength light that is transmitted through the optical filter assembly 106, Gᵢₙₙₑᵣ is the intensity of the green wavelength light as measured by the interior light sensor 107a, and Gₒᵤₜₑᵣ is the intensity of the green wavelength light as measured by the exterior light sensor 107b; and % T_{B} is the percent of blue wavelength light that is transmitted through the optical filter assembly 106, Bᵢₙₙₑᵣ is the intensity of the blue wavelength light as measured by the interior light sensor 107a, and Bₒᵤₜₑᵣ is the intensity of the blue wavelength light as measured by the exterior light sensor 107b. In the depicted embodiment, and in respect of Equations (1) to (3), the RGB readings output by the sensors 107 scale linearly with irradiance; in different embodiments, the RGB readings may scale non-linearly with irradiance if the nature of the non-linear scaling is known and compensated for.

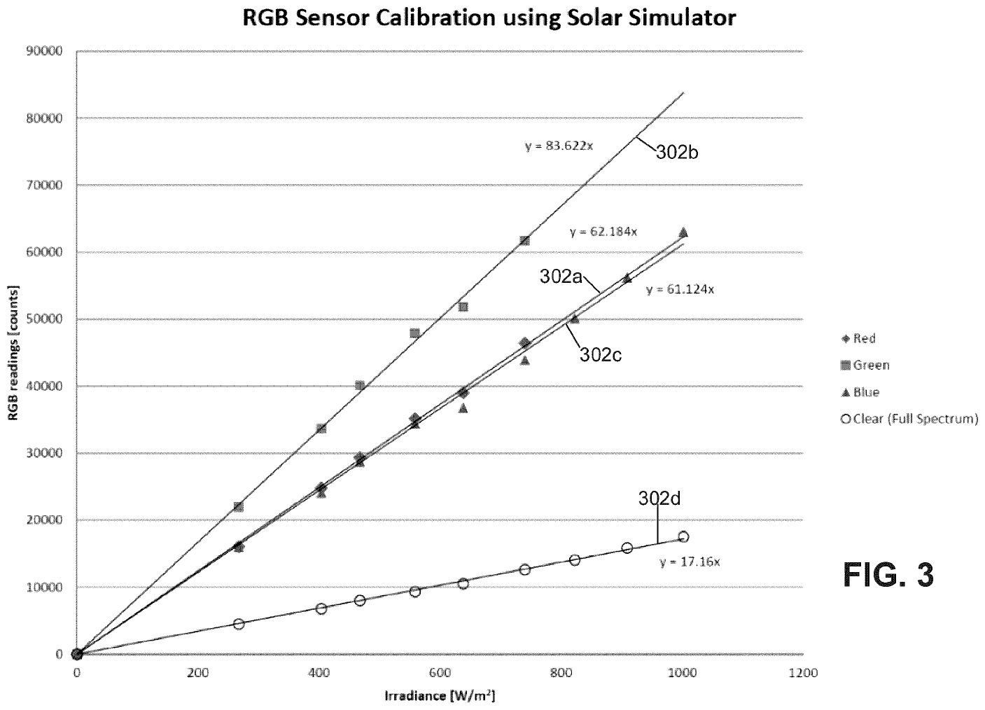

FIG. 3 shows an example set of calibration curves 302a-d in sensor counts vs. irradiance (W/m²) for an example type of RGB sensor that can be used for each of the sensors 107. The RGB sensor is a ROHM™ Semiconductor BH1745NUC sensor and calibration is performed using a Sciencetech™ Inc. 200-100 solar simulator. A first curve 302a shows the generally linear relationship between the sensor reading and irradiance for red light at approximately 625 nm; a second curve 302b shows the generally linear relationship between the sensor reading and irradiance for green light at approximately 540 nm; a third curve 302c shows the generally linear relationship between the sensor reading and irradiance for blue light at approximately 465 nm; and a fourth curve 302d shows the generally linear relationship between the sensor reading and irradiance for white light (i.e., the full visible spectrum).

From the percent transmittance values determined in Equations (1) to (3), the controller 108 can determine the color of the window using Equations (4) to (6):

R_{WINDOW}=%T_{R}·255 (4)

G_{WINDOW}=%T_{G}·255 (5)

B_{WINDOW}=%T_{B}·255 (6)

where R_{WINDOW}, G_{WINDOW}, and B_{WINDOW} represent a reading, from 1 (minimum) to 255 (maximum), of the level of red, green, and blue, respectively, being transmitted through the window, and where 255 is a number representing transmittance of ideal, white light. While 255 is used to represent ideal, white light in this example embodiment, in different embodiments (not depicted) a number other than 255 may be used.

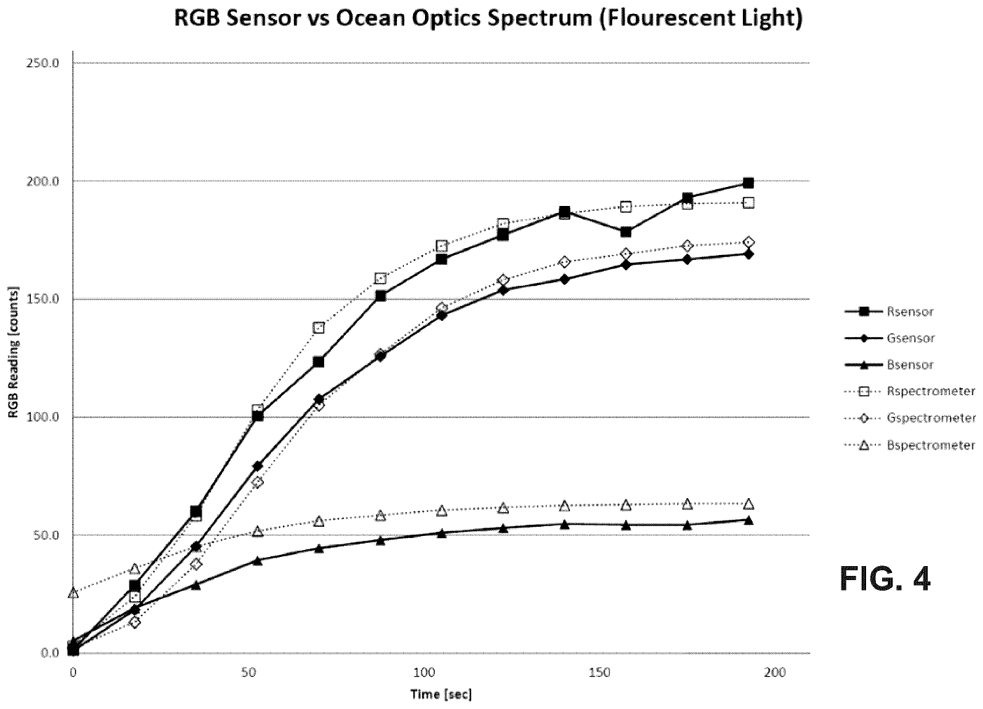

In order to test Equations (4) to (6), a film comprising the switching material was faded under fluorescent light and transmitted light that had passed through the film as it was fading was measured both by one of the sensors 107 and by an independently calibrated Ocean Optics™ spectrophotometer. FIG. 4 shows R_{WINDOW}, G_{WINDOW}, and B_{WINDOW}, as determined using Equations (4) to (6), from data obtained using one of the sensors 107 and from data obtained using the spectrophotometer. As FIG. 4 shows, the red, green, and blue readings obtained using the sensors 107 and the spectrophotometer substantially correspond.

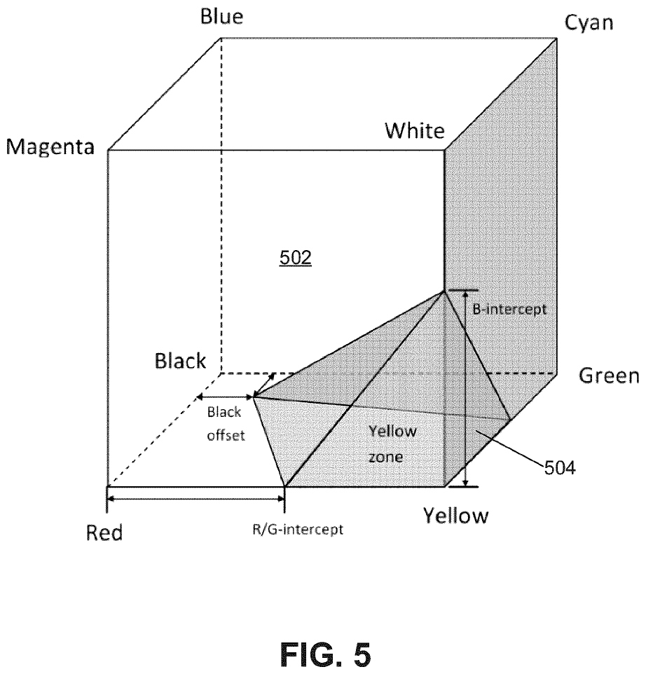

In some embodiments, the controller 108 may be configured to prevent the window from fading into a color region such that the transmitted light comprises a subset of a color space (“undesirable color zone”) comprising the red, green, and blue wavelengths, the intensities of light at which the controller 108 evaluates using Equations (4) to (6). An example red, green, and blue color space 502 is shown in FIG. 5, with the undesirable color zone 504 shown centered on the yellow corner of the color space 502. In FIG. 5, the undesirable color zone 504 is defined by the intercept on the red and green axes (“RIG-intercept”), a B-intercept, and a black offset, as labelled in FIG. 5. The RIG-intercept is defined as the value of green when blue=0 and red=255 or the value of red when blue=0 and green=255. The B-intercept is defined as the value of blue when green=255 and red=255. The black offset is defined as the red and green values below which no yellow can be perceived; the black offset is used to prevent the controller 108 from inadvertently detecting yellow in the switching material before the optical assembly 106 has lightened beyond a minimum transmittance threshold.

In a different embodiment (not depicted), the R/G-intercept is defined as the value of red when blue=0 and green=255. While in the depicted embodiment the intercepts on the red and green axes are selected to be equal, in different embodiments (not depicted) different red and green intercepts may be used, in which case the undesirable color zone 504 is defined by an R-intercept, a G-intercept, the B-intercept, and the black offset.

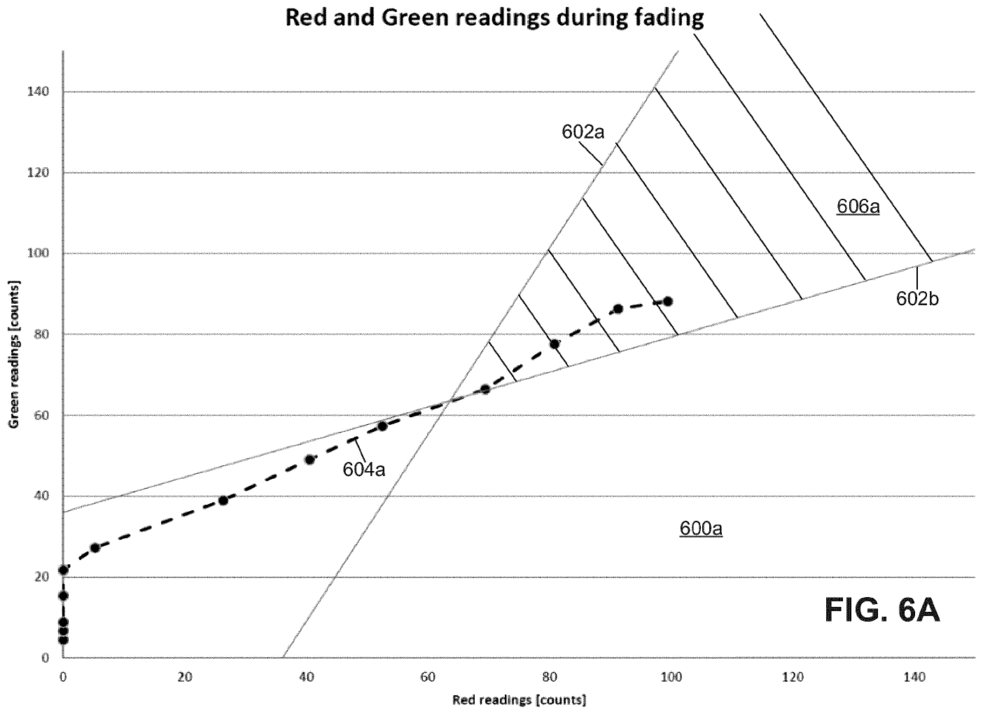

The controller 108 determines whether the red, green, and blue values determined using Equations (4) to (6) comprise part of the undesirable color zone 504; examples of this determination are depicted in FIGS. 6A and 6B. FIG. 6A is a plot 600a of G_{WINDOW} vs. R_{WINDOW}. A first readings curve 604a shows an effective color comprising a combination of green and red as represented by the G_{WINDOW} and R_{WINDOW} readings as determined by the controller 108 at different times. R/G-intercept curves 602a,b define a first undesirable area 606a in the top, right side of the plot 600a that corresponds to the portion of the undesirable color zone 504 projected on to the plot 600a. Similarly, FIG. 6B is a plot 600b of B_{WINDOW} vs. R_{WINDOW}. A second readings curve 604b shows an effective color comprising a combination of blue and red as represented by the B_{WINDOW} and R_{WINDOW} readings as determined by the controller 108 at different times. A B-intercept curve 602c defines a second undesirable area 606b in the bottom, right side of the plot 600b that corresponds to the portion of the undesirable color zone 504 projected to the plot 600b. If at least one of the readings curves 604a,b enters the undesirable areas 606a,b as the assembly 106 lightens, the controller 108 decreases the voltage applied to the assembly 106 to at least decrease, and in some embodiments to halt or to reverse, the assembly's 106 lightening rate. In embodiments in which the controller 108 decreases the voltage sufficiently to permit incident light L to darken the assembly 106 such that the readings curves 604a,b exit the undesirable areas 606a,b, a person on the inside of the vehicle ceases to observe the undesirable color, which in the case of the depicted example embodiment is yellow, once the assembly 106 sufficiently darkens.

In the embodiments of FIGS. 5, 6A, and 6B, the undesirable color zone 504 is defined by the R/G-intercept, the B-intercept, and the black offset, with the boundaries of the undesirable color zone 504 representing threshold colors that cause the controller 108 to decrease power delivered to the assembly 106 when the readings determined using the controller 108 crosses those threshold colors. However, as mentioned above in respect of different embodiments (not depicted), the undesirable color zone 504 may be differently defined, such as by separately specifying an R-intercept and a G-intercept, and such as by defining a color space other than the red, green, and blue color space.

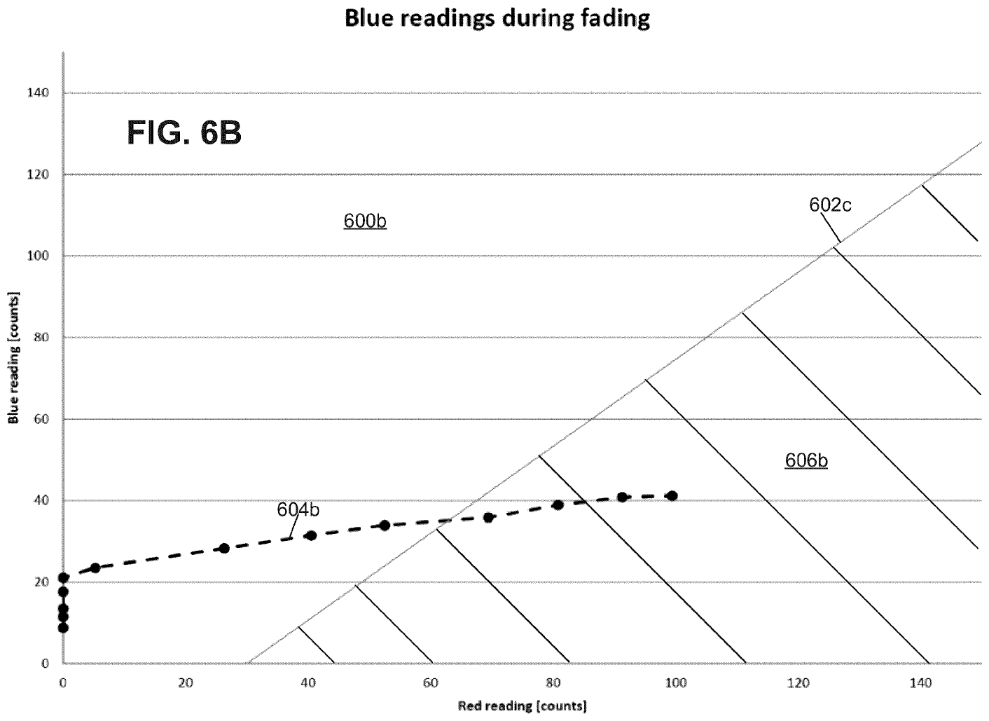

In additional different embodiments, the undesirable color zone 504 is a subset of a two-dimensional color space 502 comprising intensity measurements of two different wavelengths of light. Referring now to FIG. 7, there is shown a plot 600c of B_{WINDOW} vs. G_{WINDOW}. Each of first through third trajectory curves 702a-c represents an effective color comprising a combination of blue and green that the filter assembly 106 is able to generate for different environmental conditions. For example, the first trajectory curve 702a may represent the effective color obtained when the assembly 106 is operating in light of a first intensity and at a first temperature; the second trajectory curve 702b may represent the effective color obtained when the assembly 106 is operating in light of a second intensity and at a second temperature; and the third trajectory curve 702c may represent the effective color obtained when the assembly 106 is operating in light of a third intensity and at a third temperature, where each of the first through third temperatures is different and each of the first through third temperatures is different.

During empirical testing, it has been shown that varying the intensity of the light incident on one embodiment of the assemblies 106 comprising a hybrid photochromic/electrochromic switching material generates similar trajectory curves 702. Additionally, varying temperature in which those assemblies 106 operate causes the start and end points of each of the trajectory curves 702 to change, but between the start and end points the different trajectory curves 702 resulting from different temperatures are similar.

FIG. 7 also shows an undesirable color zone threshold curve 704 that intersects all of the trajectory curves 702a-c and that delineates that area of the color space 502 that represents a color that is deemed to be acceptable (that below the curve 704) and the unacceptable area 606c that represents a color that is deemed to be unacceptable (that above the curve 704). If the assembly 106 as evidenced by the readings curve 604 is outside of the undesirable color zone 504 and is to be faded, the controller 108 applies voltage until the blue and green sensors read a value that falls on the border of the undesirable color zone 504, after which voltage will be removed from the device to prevent further fading.

While the embodiments of FIGS. 6A and 6B define the color space 502 using three different wavelengths and the embodiment of FIG. 7 defines the color space 502 using two different wavelengths, in different embodiments (not depicted), the color space 502 may be defined using a single wavelength. The switching material used in those different embodiments has only a single color trajectory curve 702, or for practical purposes can be modeled as having only a single color trajectory curve 702, regardless of operating conditions such as temperature and incident light intensity. In those different embodiments, the color space is a line and the undesirable color zone 504 comprises a portion of that line.

While the threshold curve 704 is shown as being linear in FIG. 7, in different embodiments (not depicted) the threshold curve 704 may be non-linear.

The undesirable color zone 504 may be defined empirically by fading more than one of the assemblies 106, monitoring the color of each of the assemblies 106 during the fading, and determining a threshold color at which each of the assemblies 106 is undesirable (e.g., to a typical observer, too yellow).

In the embodiments described above, the controller 108 determines R_{WINDOW}, G_{WINDOW}, and B_{WINDOW} based on percent transmittance determined by comparing measurements obtained using the interior and exterior sensors 107. However, in a different embodiment (not depicted), the controller 108 does not use any measurements obtained using the exterior sensor 107b, and instead determines R_{WINDOW}, G_{WINDOW}, and B_{WINDOW} as the readings that the interior sensor 107a alone outputs as intensity at each of the red, green, and blue wavelengths.

### Intermediate State

In addition to or as an alternative to the above described embodiments in which one or both of the sensors 107 is used to adjust the transmittance of the assembly 106, in some embodiments and as described below the controller 108 maintains the transmittance of the assembly 106 in an intermediate state between the assembly's 106 dark and faded states. “Maintaining” the transmittance of the assembly 106 in an intermediate state refers to maintaining the transmittance at approximately an intermediate transmittance between the maximum and minimum transmittances of the assembly 106, where “approximately” in this context refers to within 50% of the intermediate transmittance, 40% of the intermediate transmittance, 30% of the intermediate transmittance, 20% of the intermediate transmittance, or 10% of the intermediate transmittance, depending on the embodiment.

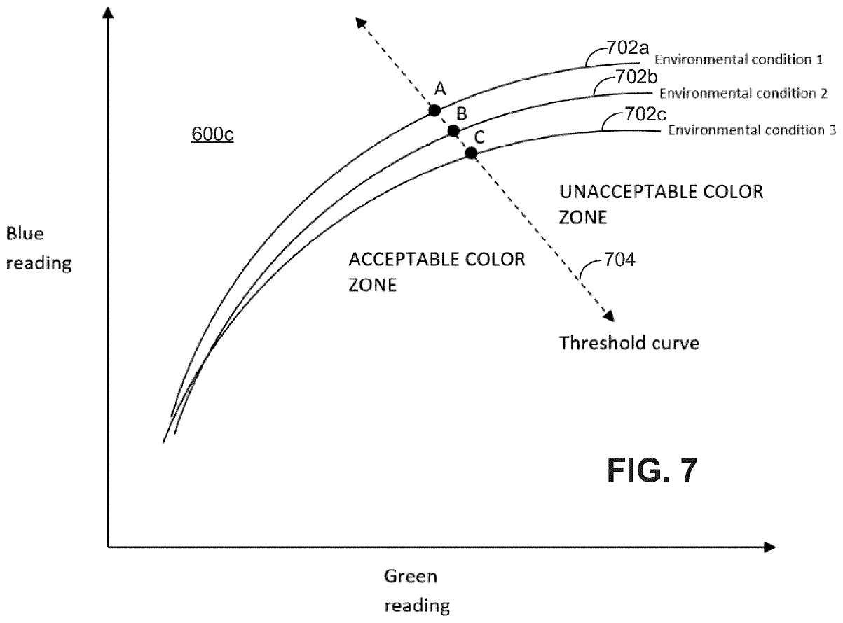

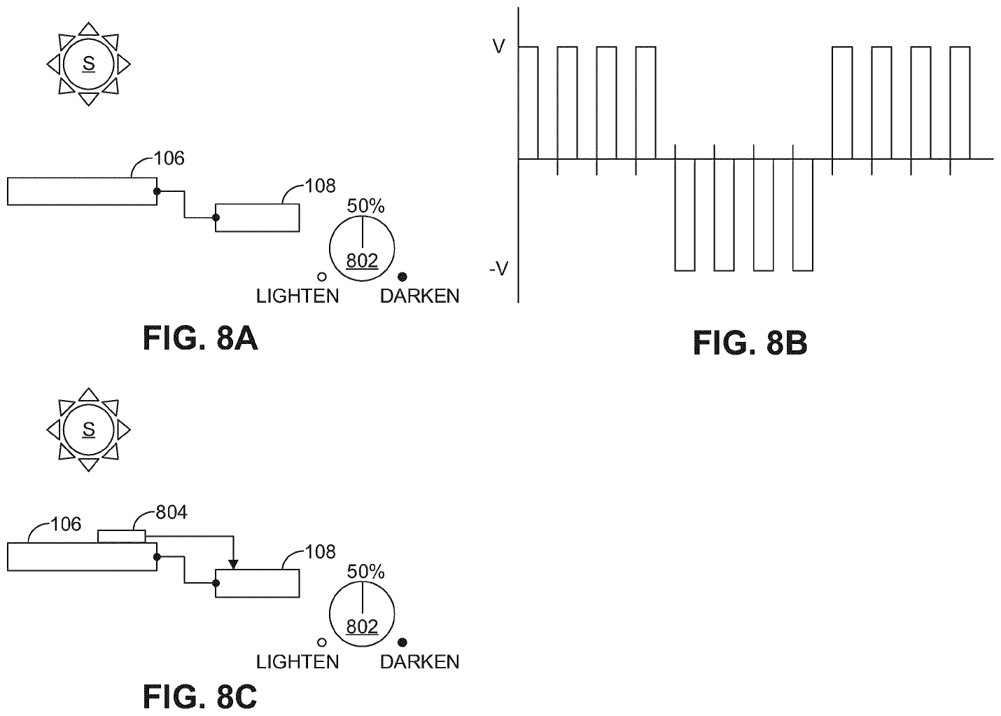

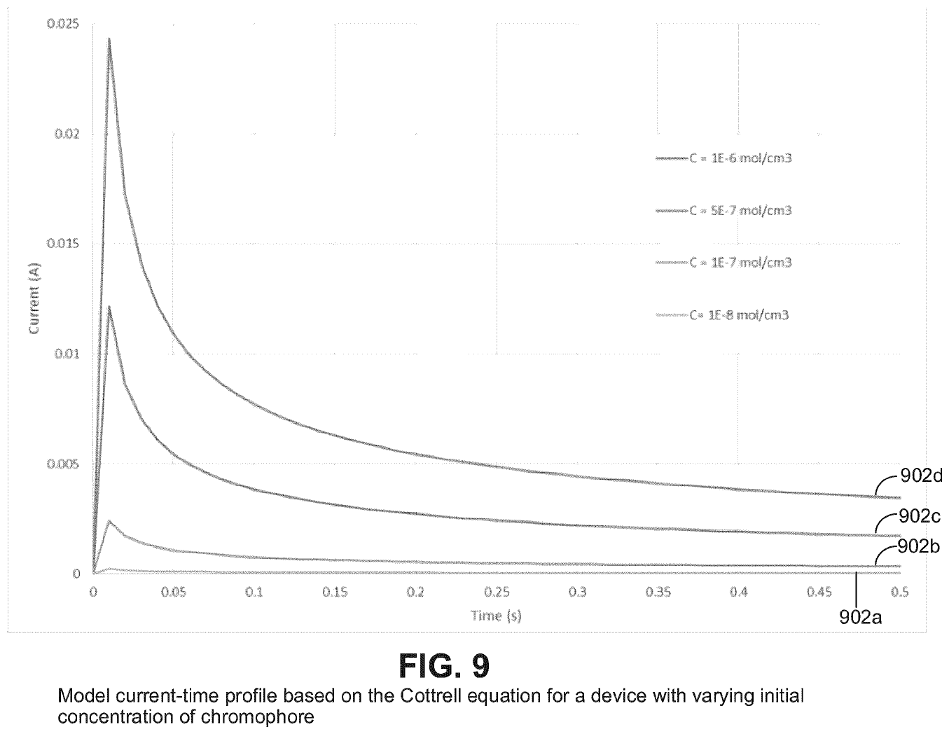

Referring now to FIG. 8A, there is shown an example system 800 comprising the optical filter assembly 106, the controller 108, and a user adjustable dial 802 that controls the duty cycle of a pulse width modulation (“PWM”) signal that applies power to the assembly 106 and that, together with the light from the light source S, controls the fading and darkening of the assembly 106. FIG. 8B shows how the position of the dial 802 adjusts the duty cycle of the PWM signal and shows a PWM signal having a 50% duty cycle.

Using the system 800 of FIG. 8A, it has been experimentally found that in relatively bright light conditions (e.g., bright sunlight), a PWM duty cycle of approximately 10% to 100% is required in order to reach intermediate states in which the assembly 106 had 25%, 50%, and 75% transmittance; accordingly, the power required to be applied to the assembly to fade it lessens with the intensity of the light incident on the assembly 106. In relatively dim light conditions (e.g., cloudy outdoor conditions), it has been experimentally found that a PWM duty cycle of 0% to approximately 50% was required to achieve those same intermediate states. For example, if a PWM signal having a 50% duty cycle is used to transition the assembly 106 from the dark state to, and to hold the assembly 106 at, an intermediate state of 75% transmittance, the controller 108 applies the PWM signal of 50% duty cycle when the assembly 106 is in the dark state and, through continued application of the signal while the light source S is at constant intensity, causes the assembly 106 to eventually reach and remain at 75% transmittance.

In one example embodiment as shown in FIG. 8C, the system 802 of FIG. 8A is augmented with a photodiode 804 positioned to sense incident light on the assembly 106, and the controller 108 is configured to adjust the PWM duty cycle in response to the intensity of the sensed incident light. More particularly, the controller 108 decreases the duty cycle, or range of duty cycles, used as the intensity of the incident light decreases and increases the duty cycle, or range of duty cycles, used as the intensity of the incident light increases. For example, in one example embodiment of the window assembly 100, the photodiode 804 may be used as the interior sensor 107a, the assembly 100 may lack the exterior sensor 107b, and the controller 108 may increase the duty cycle of the PWM signal as the intensity of light measured by the interior sensor 107a decreases below a low intensity threshold, which may or may not be user set, and decrease the duty cycle as the intensity of light measured by the interior sensor 107a increases beyond a high intensity threshold, which may or may not be user set.

One problem encountered when fading the assembly 106 using a PWM signal with a duty cycle of less than 100% is that the shorter the duty cycle, the slower the rate at which the assembly 106 fades. For example, if the fade time of the assembly 106 from 100% transmittance to 0% transmittance is one minute when the controller 108 applies a PWM signal of 100% duty cycle to the assembly 106, the corresponding fade time is at least two minutes when the controller 108 applies a PWM signal of 50% duty cycle and is at least four minutes when the controller 108 applies a PWM signal of 25% duty cycle.

To address this problem, in one embodiment the controller 108 determines or is pre-programmed (e.g., in a lookup table) with the fade time for the assembly 106. Then, in order to fade or lighten the window to a desired intermediate transmittance, the controller 108 applies a first PWM signal with a first duty cycle for a first time period until the assembly 106 reaches the desired intermediate transmittance and subsequently applies a second PWM signal with a second duty cycle to hold the assembly 106 at that desired intermediate transmittance. If the controller 108 is lightening the assembly 106, the first duty cycle is greater than the second duty cycle; conversely, if the controller 108 is darkening the assembly 106, the first duty cycle is less than the second duty cycle. To determine when to transition from the first PWM signal to the second PWM signal, the controller 108 may either rely on the duration for which the first PWM signal has been applied or on a measured transmittance of the assembly 108 using sensors such as the photodiode 804 and one or both of the interior and exterior sensors 107.

For example, in one example application, the assembly 106 begins in the dark state and receives instructions from a user via the dial 802 to transition to 50% transmittance from 0% transmittance, which is the dark state. The controller 108 consequently applies a the PWM signal with a 100% duty cycle for 30 seconds to fade the assembly 106 to 50% transmittance, and then reduces the duty cycle to 50% to hold the window at that desired transmittance. In this example, the first duty cycle is 100%, the second duty cycle is 50%, and the first time period is 30 seconds.

In some embodiments in which the switching material used in the assembly 106 comprises different chromophores, it has been experimentally determined that the PWM signal is to be applied for a minimum duration in order to cause of certain chromophores, fading regardless of incident light intensity. For example, in one example embodiment in which the switching material comprises blue and red chromophores and the PWM signal has a period of one second, the blue chromophore requires application of a PWM signal of at least 30% duty cycle before fading and the red chromophore require application of a PWM signal of at least 50% duty cycle before fading. In order to address this problem, in certain embodiments the period of the PWM signal is increased so that the duration for which a non-zero voltage is applied to the assembly 106 is sufficient to cause at least one of the chromophores in the assembly 106 to fade notwithstanding that the duty cycle of the PWM signal is unchanged. For example, while a PWM signal having a duty cycle of 25% and a period of one second is insufficient to cause the blue or red chromophores to fade, a PWM signal having a duty cycle of 25% and a period of two seconds is sufficient to cause both chromophores to fade.

Additionally, it has been observed experimentally that once the chromophores have faded, the period and duty cycle may be reduced to levels that are insufficient to fade the assembly 106, but that are sufficient to hold the assembly 106 at an intermediate state. For example, in the embodiment described above in which a PWM signal of 25% duty cycle and one second period is insufficient to cause the assembly 106 to fade, a PWM signal of 100% duty cycle and one second period may be applied to cause the assembly 106 to fade to a desired intermediate transmittance following which the controller 106 may revert to applying a PWM signal of 25% duty cycle and one second period to hold the assembly 106 at the intermediate transmittance.

Additionally or alternatively, the controller 108 may adjust the PWM signal such that the PWM signal has a non-zero voltage even when not at peak positive or negative voltages. For example, while in FIG. 8B the PWM signal oscillates between 0 V and peak positive and negative voltages, in embodiments in which the PWM signal has a non-zero voltage even when off the PWM signal oscillates between the peak positive and negative voltages when on and one or more non-zero voltages when off (“non-zero off voltage”); for example, when the optical assembly 106 comprises a switching material that has dimensions of 30 cm×30 cm the PWM signal may oscillate between the peak positive voltage and a non-zero off voltage of 0.7 V when positive, and the peak negative voltage and a non-zero off voltage of −0.7 V when negative. Having the PWM signal oscillate between its peak positive and negative voltages and a non-zero off voltage helps to maintain charge in the conductive substrate comprising the assembly 106, thereby facilitating fading.

In another embodiment, the controller 108 determines the transmittance of the filter assembly 106 based on the intensities of the certain wavelengths of light measured by the sensors 107, such as the intensities of the blue and green wavelengths of light readings of FIG. 7. For example, in respect of FIG. 7 each of blue and green readings defining a point on the curves 702a-c is associated in a lookup table with a transmittance of the switching material at the operating conditions associated with that particular one of the trajectory curves 702a-c. The controller 108 is accordingly able to determine the transmittance of the assembly 106 from the blue and green readings of FIG. 7 in addition to determining whether the effective color seen by the user is within the undesirable color zone 504. In one embodiment, the controller 108 uses this determined transmittance value to maintain the assembly 108 at an intermediate state, as discussed in further detail below.

### Current Measurements

According to another embodiment, the intermediate state of the window 100 may be controlled through current measurements. There are three contributors to the current passing through the switching material, which in this example embodiment comprises a film, comprising the optical assembly 106: Faradaic current, capacitive current, and parasitic current. The capacitive current flows in order to charge the electrochemical double layer that comprises the film. The Faradaic current is the current that flows in response to electrochemical reactions involved in oxidation of the closed-state chromophore and reduction of charge compensator in the film. The parasitic current is any current that is not contributing to electrofading of the film (i.e., non-Faradaic, non-capacitive current). The relationship between total current (Iₜₒₜₐₗ) through the film and Faradaic current (I_{Faradaic}), capacitive current (I_{capacitive}), and parasitic current (I_{parasitic}) is given by Equation (7):

Iₜₒₜₐₗ=I_{Faradaic}+I_{capacitive}+I_{parasitic} (7)

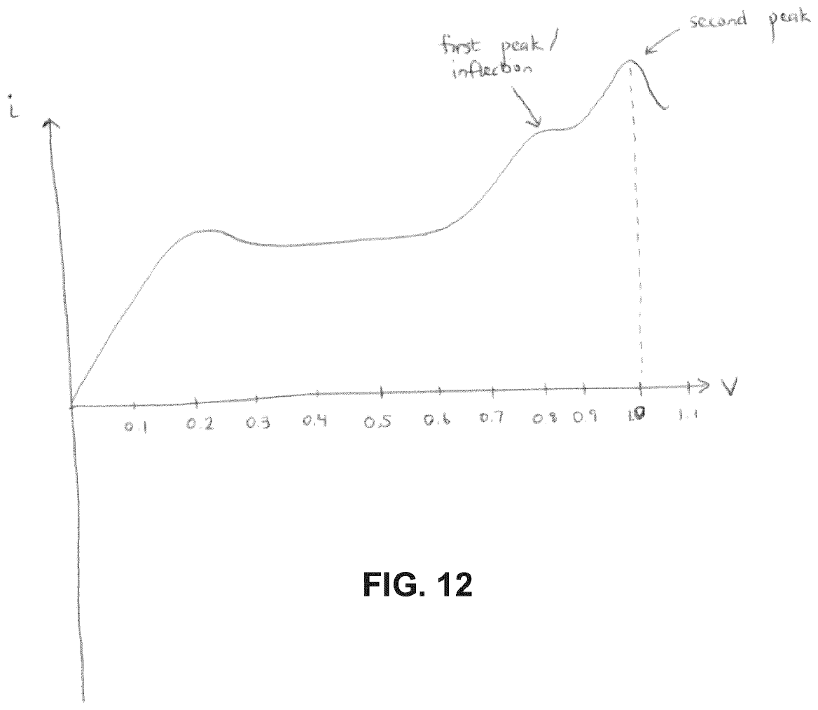

In another example embodiment, the controller 108 is equipped with a means of measuring the current being output to the film. In one embodiment, this is done through the use of a small shunt resistor electrically coupled to the controller 108 as depicted in FIG. 11, and measuring the voltage across the shunt resistor is done to determine the current flowing to the film. When a voltage is applied to lighten the film, the current through the shunt resistor spikes and then reduces as the film lightens and the chromophores fade.

In some example embodiments, the current through the film drops to a certain level (a “fully lightened threshold”) indicates the film has fully lightened. In some embodiments, the controller 108 consequently ceases applying the voltage across the film. Alternatively, in some embodiments, measuring the current to the film is used to determine the degree of lightening of the film. For example, measuring the total current that has flowed to the film since the fading cycle has commenced in some embodiments is used to estimate how much of the switching material has faded and hence the faded state of the window.

Additionally or alternatively, in some embodiments an instantaneous measurement of steady-state current flowing through the film provides an estimate of the light levels outside and how much current is required to maintain the window in a certain state. For example, on a sunny day the chromophores are constantly being switched to the dark state by the sun and back to the light state by the electricity, whereas at night, once switched to the light state, the chromophores are not as likely to switch back to the dark state absent incident light. Hence, in these embodiments a lower steady-state current indicates that the duty cycle of the applied PWM signal may be reduced by the controller 108 to maintain the window in the light state, whereas a higher steady-state current indicates bright light conditions and that the duty cycle of the applied PWM signal may be increased by the controller 108 in order to maintain the film in a lightened state or a certain intermediate state.

Assuming that the capacitive and parasitic currents are constant throughout the lifetime of the film and that each of the current measurements is obtained at the same temperature, then the transmittance of the film may be determined by measuring the current through the film in response to the voltage applied across the film that causes the film to fade.

The Cottrell equation governs the current response of the film to a potential step in voltage across the film:

$$I ( t ) = \frac{n F A {D}_{0}^{1 / 2} {C}_{0}}{\sqrt{π t}} \qquad ( 8 )$$

where I(t) is the current (Amperes), n is the number of electrons transferred, F is Faraday's constant (96,485 C·mol⁻¹), A is the area of the electrode (cm²), D₀ is the diffusion coefficient (cm²·s⁻¹), C₀ is the concentration of the chromophore at time=0 seconds (mol·cm⁻³), and t is time (s).

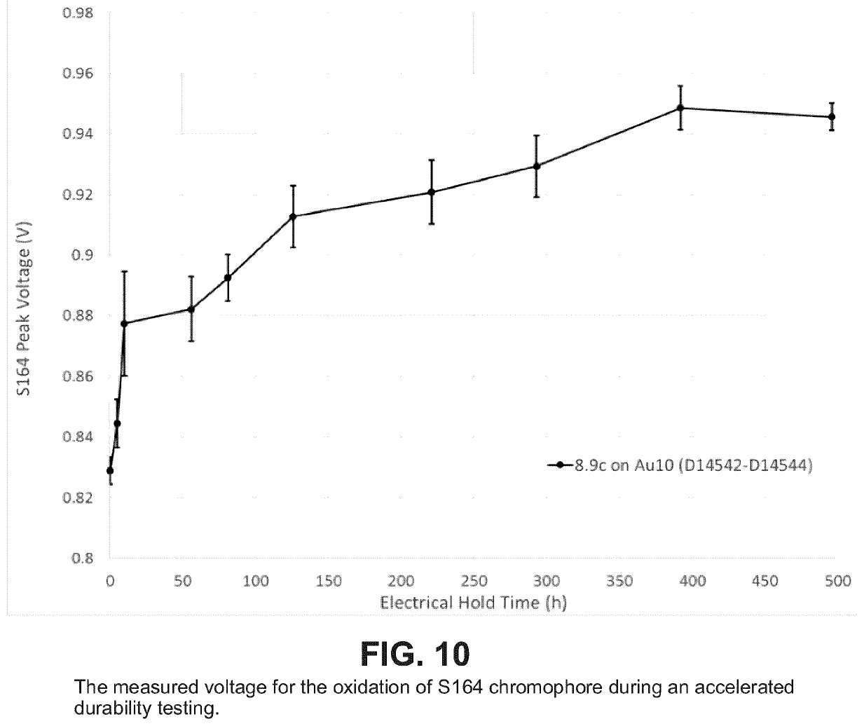

FIG. 9 is a model current-time profile for an example one of the assemblies 106 comprising a film having varying amounts of closed-state chromophore; a first curve 902a represents an initial concentration of 1×10⁻⁸ mol/cm³; a second curve 902b represents an initial concentration of 1×10⁻⁷ mol/cm³; a third curve 902c represents an initial concentration of 5×10⁻⁷ mol/cm³; and a fourth curve 902d represents an initial concentration of 1×10⁻⁶ mol/cm³. The absorbance of the film of given thickness is a function of the concentration of the closed-state chromophore. From FIG. 9, it can be observed that higher concentrations of chromophore, and thus darker films, lead to higher currents at a specific time. This can be taken advantage of to determine the faded state of the chromophore. A calibration curve of the light transmittance of the film against the current measured at a specific time after applying a specific voltage can be generated. By measuring the current and then referring back to the calibration curve, the transmittance of the film can be determined non-spectroscopically.

In some embodiments, the controller 108 is turned on by the user, or by the vehicle's electronic system when the vehicle is started up, or automatically based on one or both of motion and light sensors to detect when the vehicle is in use. The user control may comprise any one or more of a push button, a remote control, an app on a smart phone, and other wired or wireless methods of communicating to the controller 108. Wireless methods for communicating with the controller 108 may comprise Bluetooth™, wifi, infra-red, sound (e.g., voice activated), etc. Any of the methods may be used to turn the controller 108 on and off or to set the desired window transmittance or light level.

The controller 108 can also be turned off by the same methods. For example, the controller 108 can be turned off by the user through a button, an electronic signal, a wireless signal, or sound-activated signal. The controller 108 can also turn off automatically when the vehicle is turned off, or when the vehicle has been stationary for an extended period of time. The automatic-off function can also be triggered by the controller 108 measuring current going to the window assembly 100, or feedback from one or both of the sensors 107. In the embodiment in which the controller 108 relies on current measurements, the controller 108 measures the current to determine when lightening of the film has completed and turns the electricity off either temporarily or until it receives some other signal to apply electricity again. In the embodiment in which the controller 108 relies on feedback from one or both of the sensors 107, the controller 108 turns off power to the window assembly 100 automatically if the sensor 107 or sensors 107 being monitored indicate the window assembly 100 has lightened, and turns it back on again if the window assembly 100 begins to darken. In another embodiment, once the window assembly 100 is switched to the light state at night, no further electricity is required to keep them in the light state. In this embodiment, the sensors 107 could detect that it is night time outside and thus let the controller 108 know to only apply the voltage across the optical filter assembly 106 for the length of time required to lighten the window assembly 100.

In some embodiments to address the possibility of the vehicle being involved in a motor vehicle accident, the controller 108 receives a signal indicating that the vehicle has been in an accident, which causes the controller 108 to automatically cause the window assembly 108 to lighten; for example, the signal may be from the accident-detection system in the vehicle (e.g., from the sensors to deploy air bags), or the controller 108 may be communicatively coupled to a standalone or built-in accelerometer or accelerometers separate from other systems in the vehicle. Lightening the window assembly 100 in the case of an accident makes it easier for rescue personnel to see inside the vehicle and for passengers inside the car to see outside to determine whether it is safe to exit or not.

### Improving Window Operating Characteristics

Additionally or alternatively to maintaining the window assembly 100 at an intermediate state, in some embodiments the controller 108 also changes the voltage applied to the filter assembly 106 to improve window characteristics such as kinetics or durability. In some embodiments the controller 108 additionally or alternatively runs tests on the window assembly 100 during its lifetime to determine window characteristics for use in adapting the method used by the controller 108 to control the filter assembly 106 and to improve the user experience.

### i) Kinetics

Applying an over-voltage (i.e., a voltage that exceeds a minimum voltage required to lighten the filter assembly 106) to the filter assembly 106 improves kinetics (i.e., lightening rate relative to when a lower voltage is applied to the assembly 106), but in some embodiments leads to premature degradation of the switching material. As a result, in some embodiments the controller 108 is configured via its programming to apply an over-voltage during an initial fading period (e.g., the first few seconds of fading) and to then decrease the voltage during a subsequent fading period (e.g., the latter portion of the fading cycle) after the window assembly 100 has already commenced fading and, in some embodiments after it has mostly faded or is at or within a certain percentage of its desired transmittance, and to maintain the window at that desired transmittance. Lowering the voltage when voltage is to be applied for an extended period of time may help to prevent premature degradation of the switching material.

### ii) Electrical Conditioning

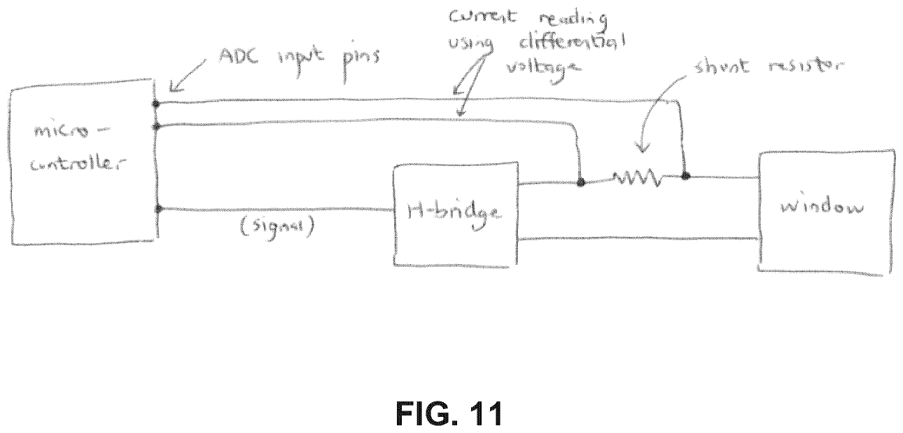

In some embodiments, the electrochemical behavior of the film comprising the switching material is relatively unstable at the beginning of or early in the film's lifecycle until it has been first used for a certain period of time (“conditioning period”), following which the behavior of the film becomes relatively stable. For example, the voltage required to electrofade the film may increase early on during an accelerated durability testing started at the beginning of the film's lifecycle but remain stable thereafter; FIG. 10 illustrates this behavior for a chromophore called the “S164 chromophore” and shows the two distinct regions. The voltage for the oxidation of the S164 chromophore increases rapidly for the first 10 hours of accelerated testing, which represents the conditioning period. After 10 hours of testing, however, the rate of change is significantly lower. If the electrofading voltage for the film is determined when the device is pristine (i.e., before the film has been conditioned), the user may notice a significant decrease in performance after expiration of the conditioning period.

In some embodiments, the assembly 106 exhibits spontaneous fading while in the dark state. Referring now to FIG. 19, which shows spectra of various examples of the assemblies 106, a group of curves 1902a represent initial dark states of the assemblies. After a period of time during which the voltage is not applied across those assemblies' 106 electrodes, those assemblies 106 no longer darken fully and exhibit spectra shown as two curves 1902b. The controller 108 conditions the assemblies 106 by applying voltage to the assemblies 106 for a certain period of time. This restores the original dark state of the assemblies 106 and allows them to fully darken. The conditioning cycle can be performed automatically by the controller 108 for a new assembly 106 that has not been used before, at regular intervals, or may be initiated by the user.

In some embodiments, a method for conditioning the film is incorporated into the controller 108 when a new, unconditioned window assembly 100 or optical filter assembly 106 is constructed. The method for conditioning comprises applying a voltage to the film for the conditioning period (e.g., a period on the order of hours, and usually fewer than 24 hours), until the device performance has equilibrated. By “equilibrated”, it is meant that peak voltage applied across the film to oxidize the switching material over a certain testing period (e.g., 15 hours) is within a certain accepted variance (e.g., 0.1 V). After the conditioning period, the electrofading voltage is determined and the conditioned window assembly 100 or optical filter assembly 106 may be used normally by a user.

iii) Cyclic Voltammetry

Along with conditioning, performing cyclic voltammetry (“CV”) on the film periodically may be used to recalibrate the controller 108 and ensure it is operating at a relatively optimal voltage for the particular weathered film. This is in contrast to using a set voltage to electrofade the film under all conditions and through the film's lifetime. The optimal voltage to apply to the film to initiate the transition to the faded state may vary with one or both of how long the film has been in use and environmental conditions. If the applied voltage is too low, the film may not undergo complete transition to its fully lightened state. If the applied voltage is too high, accelerated degradation of the film may occur.

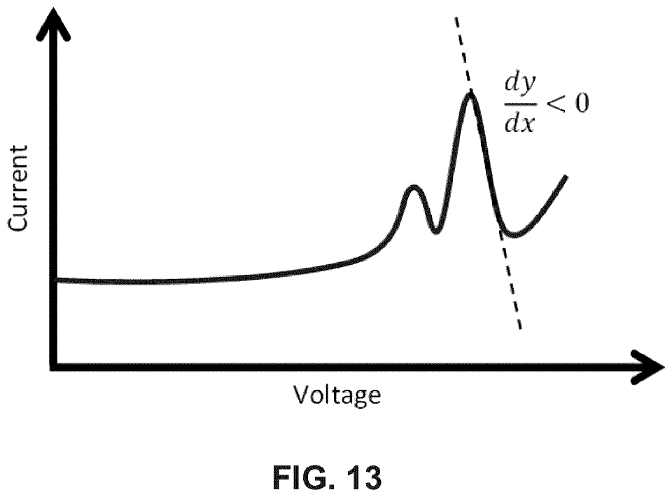

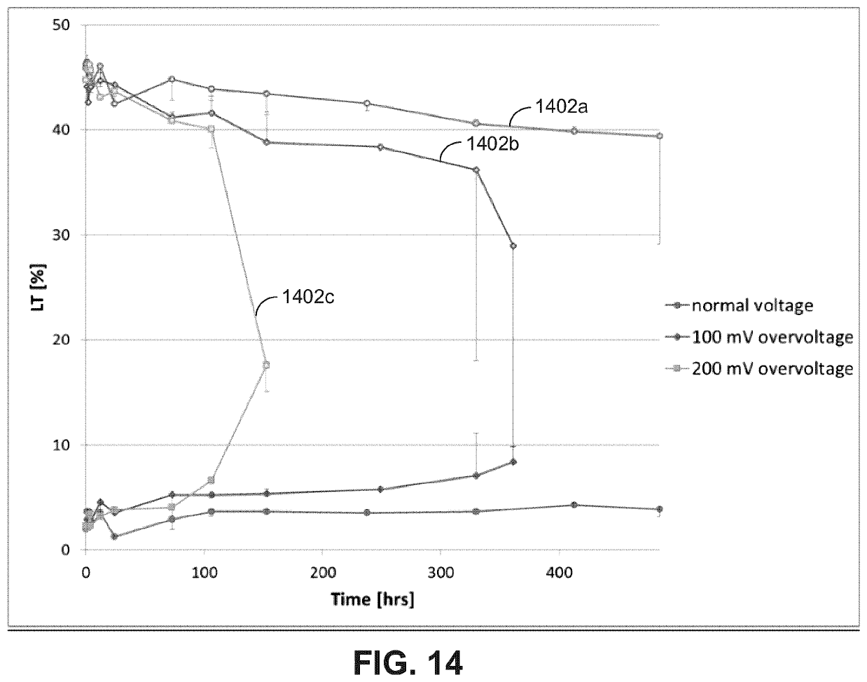

In one embodiment and as shown in FIG. 11, performing a CV may be accomplished by including a shunt resistor in series with one of the terminals of the window assembly 100. This shunt resistor is wired to the controller 108, which converts the voltage drop across the shunt resistor to a current draw. In some embodiments, the shunt resistance and resulting current draw are low enough that they do not practically affect the voltage delivered to the window assembly 100. At set intervals during the lifetime of the optical filter assembly 106 a CV is performed on the assembly 100 to recalibrate its operating voltage. To determine the recalibrated voltage, a linear sweep voltammogram (“LSV”) of the assembly 100 is acquired prior to fading. By increasing the output voltage to the window assembly 100 by a voltage increase rate (e.g., 100 mV/s) in certain stepped increments (e.g., 10 mV step increments) and monitoring the current draw of the window assembly 100, the controller 108 determines a current versus voltage profile as shown in FIG. 12 and determines the recalibrated voltage for fading the chromophore(s) comprising the switching material. Conceptually, the recalibrated voltage is defined by the boundaries of being sufficiently high so that all closed-form chromophores in the film are oxidized but not so high that film degradation is accelerated. Typically, this is a voltage 50-100 mV greater than the peak current voltage for the chromophore with the most anodic oxidation potential (or second peak in the case of FIG. 12). A ‘peak’ doesn't necessarily have to be an actual peak and could just be an inflection point on the curve. In a typical LSV of a film comprising two chromophores as shown in FIG. 13, there are two current peaks at voltages greater than 0.65 V that correspond to the oxidation of the two closed-state chromophores. To determine the recalibrated voltage based on an LSV of the film, the first and second derivatives of the LSV are calculated. In a formulation containing n chromophores the peak current voltage for the chromophore with the most anodic oxidation potential is determined by identifying the (n−1)^{th} instance of the second derivative changing from a positive value to a negative value followed by determining the voltage at which the next instance of either condition A or B is satisfied:
(a) Condition A: the first derivative equalling zero AND the second derivative being negative.
(b) Condition B: the second derivative changing from a negative value to a positive value.

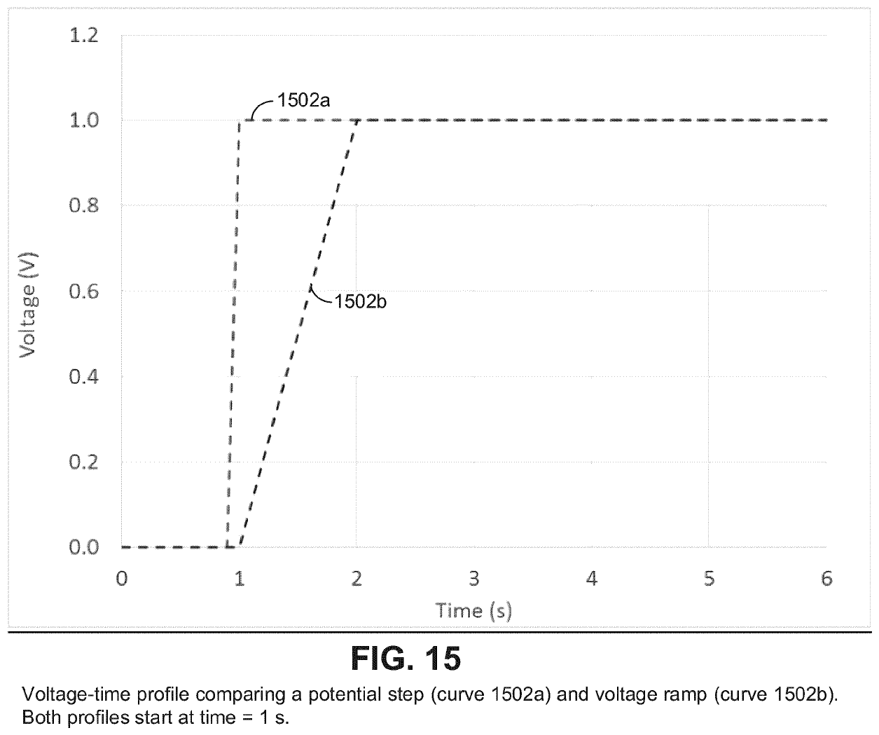

FIGS. 11 and 12, respectively show the controller 108 setup and an example CV curve used for calculating the applied voltage. As can be seen in FIG. 14, applying 100 mV or higher over-voltage during an electrical durability cycling test leads to accelerated degradation in both the light and dark states; in FIG. 14, a first curve 1402a corresponds to a normal voltage, a second curve 1402b corresponds to a 100 mV overvoltage, and a third curve 1402c corresponds to a 200 mV overvoltage.

### iv) Ramping Voltage Instead of a Square Wave

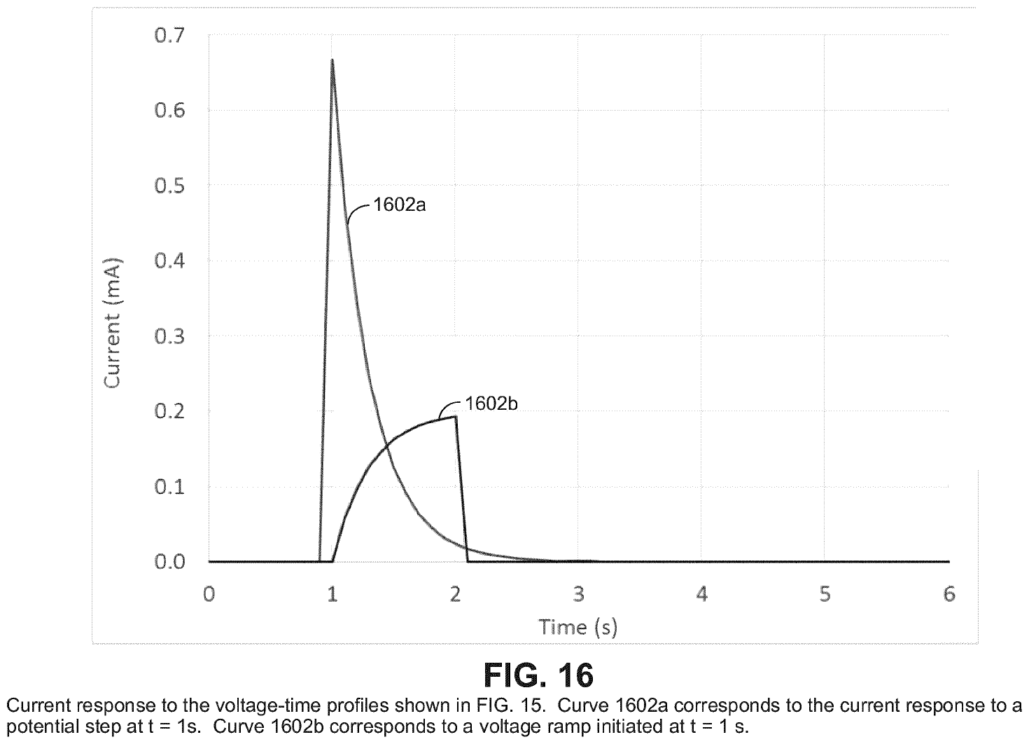

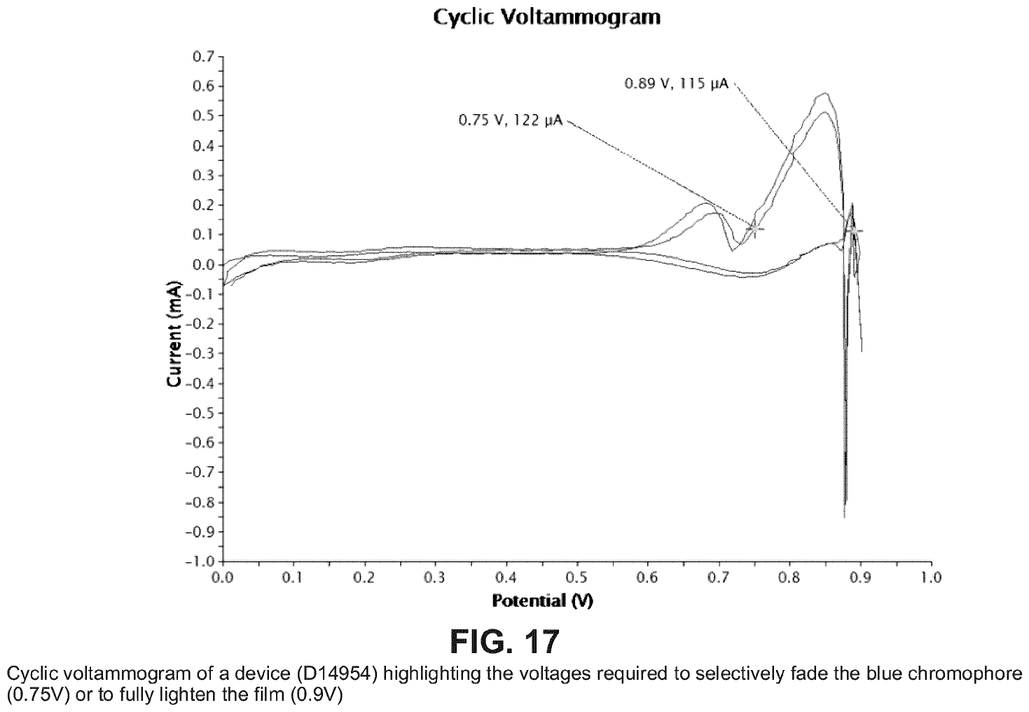

When applying the voltage as a square waveform, there is a large voltage step. In one embodiment, the voltage is increased more gradually by using either a triangular or sinusoidal waveform. Using a voltage step creates a relatively high capacitive current compared to using a voltage ramp. This can be observed in FIGS. 15 and 16, where for a model window assembly 100 the maximum current for the voltage ramp (the voltage ramp is shown as one curve 1502b in FIG. 15, and the corresponding current is shown as another curve 1602b in FIG. 16) is less than a third of that for the voltage step (the voltage step is shown as one curve 1502a in FIG. 15, and the corresponding current is shown as another curve 1602a in FIG. 16). Reducing the charging current may increase the durability of the film due to lower resistive heating of the electrodes.

### v) Temperature Dependency

Additionally or alternatively to the embodiments described above, in additional embodiments temperature may be considered when lightening the switching material. Electrochromic lightening of the film occurs when a voltage is applied across the film that is higher than the voltage at which oxidation of a ring-closed chromophore occurs. Once oxidized, the ring-closed chromophore will spontaneously ring open to the ring-opened oxidized state and then can be reduced to the neutral ring-opened state by accepting an electron from one of the electrodes or another neutral ring-closed chromophore molecule, or other electrochemically active specie.

### A Single Chromophore System:

In order to have an electrochromic or hybrid electrochromic/photochromic device switch from dark to light states or vice versa, one applies a voltage that is high enough to allow the oxidation of the ring-closed form of the chromophore. In one embodiment, one would ideally apply a voltage no higher than approximately 100 mV over the ring-closed chromophore oxidation potential, and not over approximately 250 mV more than the ring-closed oxidation potential, in order to avoid oxidation of the ring open form of the chromophore or other formulation components.

### A Two or More Chromophore System:

A benefit of using an embodiment of the film comprising multiple chromophores is to have the multiple chromophores darken in sunlight such that each of the chromophores absorbs light in different ranges of the visible light spectrum (i.e., different color chromophores) resulting in the film having a neutral grey color. When the user electrically lightens the film, it is desirable to have all chromophores ring-open (lighten) at similar rates so that the film experiences what the user perceives as a “smooth” color transition. For example, if the dark state color is grey, the appearance of the film as it electrically fades should be the disappearance of grey. If one chromophore, for example one that is red in the ring-closed state, fades more slowly than the other chromophores, the film would have a red appearance as it transitions from the darkened state to the faded state.

The challenge in a multiple chromophore system, where one would like to electrofade all chromophores, is that each chromophore may have a slightly different oxidation potential. The switching voltage is accordingly set high enough to oxidize all ring-closed chromophores. If only one chromophore oxidizes efficiently, an undesirable color change occurs upon activating the electro-chromic system (i.e., upon commencing switching by applying a voltage). However, the voltage is not set too high because this would result in damage to the film during usage as described above (see overvoltage discussion). It is generally desirable to have the voltage set no more than a specified overvoltage higher than the voltage at which the most anodic ring-closed chromophore oxidizes in the film the specified overvoltage in one embodiment is 50 mV higher than the voltage at which the most anodic ring-closed chromophore oxidizes in the film. Described another way, it is desirable to set the voltage no more than 350 mV higher than the voltage at which the least anodic ring-closed chromophore oxidizes in the film, where 350 mV is approximately the difference between the most and least anodic chromophores plus 50 mV; in different embodiments, the difference between the most and least anodic chromophores may be different than 300 mV, and the 50 mV buffer may be different from 50 mV, and may include 0 mV. A secondary constraint that applies to both scenarios is that in some embodiments the voltage is smaller than the voltage at which one or both of oxidation and reduction of all other formulation components, including ring-open chromophores, occurs (e.g. solvents, supporting electrolytes, etc.). In other words, the voltage is large enough to oxidize all ring-closed chromophores, but not large enough to oxidize or reduce anything else to which the voltage is applied in the filter assembly 106 or window assembly 100 generally.

For example, at ambient temperature (approximately 20° C.) where S158 and S164 are two different chromophores in a formulation referenced as alpha 8.7d, device D11669, the voltage required to oxidize the ring-closed state of S158 is approximately 1.02 V and the voltage required to oxidize the ring-closed state of S164 is approximately 1.19 V. A switching voltage of 1.24 V is suitable for this example.

### Effect of Temperature on Voltage:

A problem may occur when a film is designed to be used in outdoor glazing application in which the temperature can range between approximately 40° C. and 110° C. It has been observed that that there is a shift in the voltage at which ring-closed chromophores undergo oxidation as a result of being exposed to wide variations in temperature. For example, in the formulation described above (alpha 8.7d, device D11669), the ring-closed S164 oxidation potential has been measured at various temperatures (see Table 1), below.

If one sets the switching voltage based on the voltage at which S164 undergoes oxidation at 20° C. (1.24 V) and use this switching voltages at all temperatures, then the S164 chromophore would not be converted to the colorless ring-open state as efficiently at temperatures below approximately 0° C. This would result in an undesirable red color (ring-closed S164 is red) during switching. On the other hand, at temperatures above about 40° C. one would be applying a voltage that would be more than 50 mV higher than the voltage at which S164 oxidizes, decreasing the lifetime of the film due to applying an overvoltage.

### Effect of Temperature on Lifetime:

In addition it has been observed that the durability of the filter assembly 106 is affected by temperature. Applying a voltage in the presence of sunlight to lighten the assembly 106 is performed over the lifetime of the assembly 106 for several hundreds if not thousands of hours (this application of voltage is “electrical hold”). It has been observed experimentally that at higher temperatures there is an increase in the degradation rate of the assembly 106 during electrical hold, as measured by degradation of the electrodes comprising the assembly 106 and degradation of the chromophores comprising the switching material of the assembly 106. It accordingly may be beneficial to limit the operational temperature of the assembly 106 by not allowing the part to be powered at temperatures greater than some cut off temperature (e.g., 70° C.).

In some embodiments, the controller 108 that controls application of voltage across the film has a temperature measurement input that receives a signal from a temperature sensor such as a thermocouple or thermistor. By using a lookup table as shown in Table 1 below, the switching voltage can be adjusted based on the temperature of the glass on which the switching material is laminated, which is some embodiments is used as a proxy for the temperature of the switching material itself.

TABLE 1
Oxidation potentials for S158 and S164 in
device D11669 at various temperatures

| | S158 Chromophore | S164 Chromophore |
|---|---|---|
| Temperature (° C.) | Oxidation Potential (V) | Oxidation Potential (V) |
| −40 | 1.1394 | 1.3801 |
| −30 | 1.1246 | 1.375 |
| −20 | 1.1043 | 1.3347 |
| −10 | 1.085 | 1.2992 |
| 0 | 1.0543 | 1.2496 |
| 10 | 1.0298 | 1.2193 |
| 20 | 1.0153 | 1.1942 |
| 30 | 0.9899 | 1.1645 |
| 40 | 0.9748 | 1.1546 |
| 50 | 0.9551 | 1.1349 |
| 60 | 0.9206 | 1.1198 |
| 70 | 0.8945 | 1.1098 |
| 80 | 0.8697 | 1.0998 |

Accordingly, shifting voltages at various temperatures may permit a broader range of operation temperatures and a longer lifetime of the assembly 106.

### vi) Selective Electrofading of Chromophores

In one embodiment, one factor that affects the voltage required to lighten the film comprising part of the optical assembly 106 is the oxidation potential of the ring-closed chromophore. As discussed above, it may be advantageous to have multiple chromophores with absorbance maxima at different wavelengths in the ring-closed state to achieve a neutral dark state. In these multi-chromophore films, the chromophores may not have identical oxidation potentials. Typically, the voltage applied to a multi-chromophore film is selected based on the voltage required to oxidize the chromophore with the highest oxidation potential. In this way, all chromophores are oxidized when that voltage is applied and the film maintains a neutral color throughout the dark-to-light transition for chromophores that fade at similar rates.

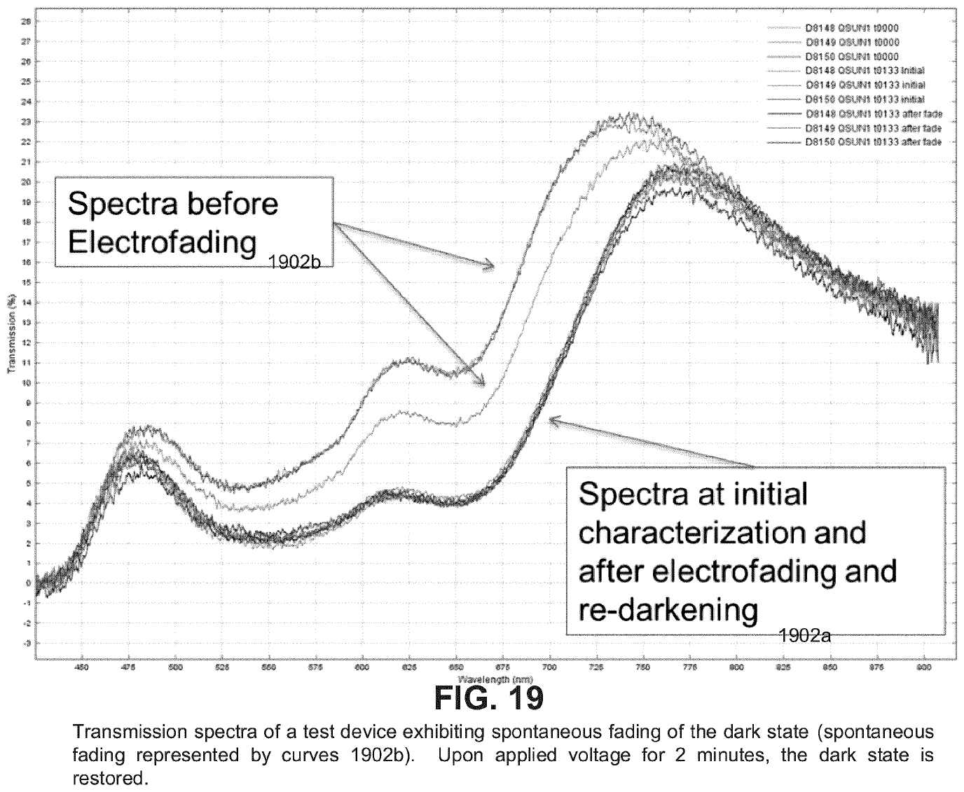

However, it may be desired for the film to attain one or more intermediate colored states during the dark-to-light transition. This can be achieved by selectively electrofading the chromophore with the lowest oxidation potential. In this scenario, only the chromophore with the lowest oxidation potential electrofades, leaving the one or more chromophores with higher oxidation potentials in their colored ring-closed states. For example, a blue and a red chromophore may be added together to achieve a neutral color in the dark state, as can be seen in a curve 1802a in FIG. 18. By applying a voltage that selectively electrofades the blue chromophore (curve labelled 0.75 V as seen in FIG. 17), the film transitions from a neutral to a red color (curve 1802b in FIG. 18). Furthermore, by applying a higher voltage upon reaching the red-colored state (curve labelled 0.9 V in FIG. 17), the film can complete the transition from red to the fully faded state (curve 1802c in FIG. 18). In a film comprising three or more chromophores, it is possible to reach several intermediate states by incrementally increasing the applied voltage, and oxidizing the chromophores with lower oxidation potentials first.

In some embodiments, a control system comprising the controller 108 applies a variable voltage across the filter assembly 106, with the voltage determined by whether the user desires an intermediate colored state (a first voltage) or a neutral faded state (a second voltage that is higher than the first voltage) during the dark-to-light transition.

For the sake of convenience, the example embodiments above are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

It is contemplated that any part of any aspect or embodiment discussed in this specification can be implemented or combined with any part of any other aspect or embodiment discussed in this specification.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. A variable transmittance vehicle window, the window comprising:
(a) a non-opaque substrate;
(b) a switching material affixed to the substrate and positioned such that at least some light that passes through the substrate also passes through the switching material;
(c) a first electrode and a second electrode electrically coupled to the switching material, wherein transmittance of the switching material decreases until reaching a minimum on exposure to a first stimulus and increases until reaching a maximum in response to application of a second stimulus, wherein at least one of the first and second stimuli comprises applying a voltage across the electrodes;
(d) voltage application circuitry for selectively applying different voltages across the electrodes;
(e) an interior light sensor positioned to measure intensity of at least one wavelength of light that has entered the interior of a vehicle comprising the window after passing through the substrate and the switching material, wherein the at least one wavelength of light is a proper subset of the visible spectrum; and
a computer readable medium and a processor communicatively coupled to the computer readable medium, the interior light sensor, and the voltage application circuitry, wherein the computer readable medium has encoded thereon program code, executable by the processor, which when executed by the processor causes the processor to:
(i) obtain an intensity measurement from the interior light sensor of the at least one wavelength of light; and
(ii) in response to the intensity measurement, increase or decrease the absolute value of the voltage applied across the electrodes such that the transmittance of the switching material is increased or decreased.

2. The window of claim 1 wherein the at least one wavelength of light comprises a range of wavelengths, and wherein the intensity measurement of the range of wavelengths is a cumulative intensity of the range of wavelengths.

3. The window of claim 2 wherein the range of wavelengths is continuous.

4. The window of claim 2 or 3 wherein the range of wavelengths comprises less than approximately 10% of the visible light spectrum, less than approximately 20% of the visible light spectrum, less than approximately 30% of the visible light spectrum, less than approximately 40% of the visible light spectrum, less than approximately 50% of the visible light spectrum, less than approximately 60% of the visible light spectrum, less than approximately 70% of the visible light spectrum, less than approximately 80% of the visible light spectrum, or less than approximately 90% of the visible light spectrum.

5. The window of any one of claims 1 to 4 wherein the at least one wavelength of light comprises at least two different wavelengths, wherein the processor obtains an intensity measurement for each of the at least two different wavelengths, and wherein the processor:
(a) determines an effective color resulting from a combination of the at least two different wavelengths;
(b) determines whether the effective color comprises part of an undesirable color zone that is a proper subset of a color space comprising the at least two different wavelengths; and
(c) increases or decreases the absolute value of the voltage in response to whether the effective color comprises part of the undesirable color zone.

6. The window of claim 5 wherein when the effective color is outside of the undesirable color zone, the processor increases the voltage to lighten the switching material.

7. The window of claim 5 or 6 wherein when the effective color is within the undesirable color zone, the processor decreases the voltage to darken the switching material.

8. The window of any one of claims 5 to 7 wherein the at least two different wavelengths are wavelengths corresponding to blue light and green light.

9. The window of any one of claims 5 to 8 further comprising a temperature sensor communicatively coupled to the processor and positioned to measure an operating temperature of the switching material, and wherein the processor determines whether the effective color is within the undesirable color zone using the operating temperature.

10. The window of any one of claims 5 to 9 further comprising an exterior light sensor communicatively coupled to the processor and positioned to measure the intensity of the at least one wavelength of light that has not passed through the switching material, and wherein the processor:
(a) determines what percentage of the at least one wavelength of light is transmitted through the substrate and the switching material; and
(b) uses the percentage of the at least one wavelength of light that is transmitted through the substrate and the switching material to determine the effective color.

11. The window of claim 1 wherein the processor increases the absolute value of the voltage to increase the transmittance of the switching material and decreases the absolute value of the voltage to decrease the transmittance of the switching material.

12. The window of claim 1 wherein the program code further causes the processor to:
(a) transition the switching material from a first transmittance to an intermediate transmittance that is between a maximum and minimum transmittance of the switching material; and
(b) maintain the switching material at approximately the intermediate transmittance for a time period.

13. The window of claim 12 wherein the first transmittance is the maximum or minimum transmittance of the switching material.

14. The window of claim 12 or 13 wherein the processor applies a pulse width modulated signal having a duty cycle of less than 100% to transition the switching material to and maintain the switching material at the intermediate transmittance.

15. The window of claim 12 or 13 wherein the processor applies a pulse width modulated signal that transitions between a non-zero peak voltage when on and a non-zero off voltage when off.

16. The window of claim 12 or 13 wherein the processor applies a first pulse width modulated signal to transition the switching material to the intermediate state and a second pulse width modulated signal to maintain the switching material at the intermediate state, wherein the first pulse width modulated signal has a duty cycle higher than that of the second pulse width modulated signal.

17. The window of any one of claims 12 to 16 wherein the program code further causes the processor to:
(a) obtain an intensity measurement from the interior light sensor of the at least one wavelength of light; and
(b) when the intensity of the at least one wavelength of light exceeds an upper intensity threshold, transition the switching material to a darker intermediate state and maintain the switching material at the darker intermediate state.

18. The window of claim 17 wherein the processor, when the intensity of the at least one wavelength of light is below a lower intensity threshold, transitions the switching material to a lighter intermediate state and maintains the switching material at the lighter intermediate state.

19. The window of any one of claims 12 to 18 wherein during the time period, the transmittance of the switching material is maintained at within 50% of the intermediate transmittance, 40% of the intermediate transmittance, 30% of the intermediate transmittance, 20% of the intermediate transmittance, or 10% of the intermediate transmittance.

20. A variable transmittance vehicle window, the window comprising:
(a) a non-opaque substrate;
(b) a switching material affixed to the substrate and positioned such that at least some light that passes through the substrate also passes through the switching material;
(c) a first electrode and a second electrode electrically coupled to the switching material, wherein transmittance of the switching material decreases until reaching a minimum on exposure to a first stimulus and increases until reaching a maximum in response to application of a second stimulus, wherein at least one of the first and second stimuli comprises applying a voltage across the electrodes;
(d) voltage application circuitry for selectively applying different voltages across the electrodes; and
(e) a computer readable medium and a processor communicatively coupled to the computer readable medium and the voltage application circuitry, wherein the computer readable medium has encoded thereon program code, executable by the processor, which when executed by the processor causes the processor to:
(i) transition the switching material from a first transmittance to an intermediate transmittance that is between a maximum and minimum transmittance of the switching material; and
(ii) maintain the switching material at approximately the intermediate transmittance for a time period.

21. The window of claim 20 wherein the first transmittance is the maximum or minimum transmittance of the switching material.

22. The window of claim 20 or 21 wherein the processor applies a pulse width modulated signal having a duty cycle of less than 100% to transition the switching material to and maintain the switching material at the intermediate transmittance.

23. The window of claim 20 or 21 wherein the processor applies a pulse width modulated signal that transitions between a non-zero peak voltage when on and a non-zero off voltage when off.

24. The window of claim 20 or 21 wherein the processor applies a first pulse width modulated signal to transition the switching material to the intermediate state and a second pulse width modulated signal to maintain the switching material at the intermediate state, wherein the first pulse width modulated signal has a duty cycle higher than that of the second pulse width modulated signal.

25. The window of any one of claims 20 to 24 further comprising an interior light sensor positioned to measure intensity of at least one wavelength of light that has entered the interior of a vehicle comprising the window after passing through the substrate and the switching material, and wherein the program code further causes the processor to:
(a) obtain an intensity measurement from the interior light sensor of the at least one wavelength of light; and
(b) when the intensity of the at least one wavelength of light exceeds an upper intensity threshold, transition the switching material to a darker intermediate state and maintain the switching material at the darker intermediate state.

26. The window of claim 25 wherein the processor, when the intensity of the at least one wavelength of light is below a lower intensity threshold, transitions the switching material to a lighter intermediate state and maintains the switching material at the lighter intermediate state.

27. The window of any one of claims 20 to 26 wherein during the time period, the transmittance of the switching material is maintained at within 50% of the intermediate transmittance, 40% of the intermediate transmittance, 30% of the intermediate transmittance, 20% of the intermediate transmittance, or 10% of the intermediate transmittance.

28. The window of claim 20 further comprising an interior light sensor communicatively coupled to the processor and positioned to measure intensity of at least one wavelength of light that has entered the interior of a vehicle comprising the window after passing through the substrate and the switching material, wherein the at least one wavelength of light is a proper subset of the visible spectrum and wherein the program code further causes the processor to:
(a) obtain an intensity measurement from the interior light sensor of the at least one wavelength of light; and
(b) in response to the intensity measurement, increase or decrease the absolute value of the voltage applied across the electrodes such that the transmittance of the switching material is increased or decreased.

29. The window of claim 28 wherein the at least one wavelength of light comprises a range of wavelengths, and wherein the intensity measurement of the range of wavelengths is a cumulative intensity of the range of wavelengths.

30. The window of claim 29 wherein the range of wavelengths is continuous.

31. The window of claim 29 or 30 wherein the range of wavelengths comprises less than approximately 10% of the visible light spectrum, less than approximately 20% of the visible light spectrum, less than approximately 30% of the visible light spectrum, less than approximately 40% of the visible light spectrum, less than approximately 50% of the visible light spectrum, less than approximately 60% of the visible light spectrum, less than approximately 70% of the visible light spectrum, less than approximately 80% of the visible light spectrum, or less than approximately 90% of the visible light spectrum.

32. The window of any one of claims 28 to 31 wherein the at least one wavelength of light comprises at least two different wavelengths, wherein the processor obtains an intensity measurement for each of the at least two different wavelengths, and wherein the processor:
(a) determines an effective color resulting from a combination of the at least two different wavelengths;
(b) determines whether the effective color comprises part of an undesirable color zone that is a proper subset of a color space comprising the at least two different wavelengths; and
(c) increases or decreases the absolute value of the voltage in response to whether the effective color comprises part of the undesirable color zone.

33. The window of claim 32 wherein when the effective color is outside of the undesirable color zone, the processor increases the voltage to lighten the switching material.

34. The window of claim 32 or 33 wherein when the effective color is within the undesirable color zone, the processor decreases the voltage to darken the switching material.

35. The window of any one of claims 32 to 34 wherein the at least two different wavelengths are wavelengths corresponding to blue light and green light.

36. The window of any one of claims 32 to 35 further comprising a temperature sensor communicatively coupled to the processor and positioned to measure an operating temperature of the switching material, and wherein the processor determines whether the effective color is within the undesirable color zone using the operating temperature.

37. The window of any one of claims 32 to 36 further comprising an exterior light sensor communicatively coupled to the processor and positioned to measure the intensity of the at least one wavelength of light that has not passed through the switching material, and wherein the processor:
(a) determines what percentage of the at least one wavelength of light is transmitted through the substrate and the switching material; and
(b) uses the percentage of the at least one wavelength of light that is transmitted through the substrate and the switching material to determine the effective color.

38. The window of claim 28 wherein the processor increases the absolute value of the voltage to increase the transmittance of the switching material and decreases the absolute value of the voltage to decrease the transmittance of the switching material.

39. A method for varying transmittance of a variable transmittance vehicle window comprising a switching material, the method comprising:
(a) obtaining, on an interior of a vehicle comprising the window, an intensity measurement of at least one wavelength of light that has passed through the window, wherein the at least one wavelength of light is a proper subset of the visible spectrum; and
(b) in response to the intensity measurement, increasing or decreasing the absolute value of the voltage applied across the electrodes such that the transmittance of the switching material is increased or decreased.

40. The method of claim 39 wherein the at least one wavelength of light comprises a range of wavelengths, and wherein the intensity measurement of the range of wavelengths is a cumulative intensity of the range of wavelengths.

41. The method of claim 40 wherein the range of wavelengths is continuous.

42. The method of claim 40 or 41 wherein the range of wavelengths comprises less than approximately 10% of the visible light spectrum, less than approximately 20% of the visible light spectrum, less than approximately 30% of the visible light spectrum, less than approximately 40% of the visible light spectrum, less than approximately 50% of the visible light spectrum, less than approximately 60% of the visible light spectrum, less than approximately 70% of the visible light spectrum, less than approximately 80% of the visible light spectrum, or less than approximately 90% of the visible light spectrum.

43. The method of any one of claims 39 to 42 wherein the at least one wavelength of light comprises at least two different wavelengths, wherein the intensity measurement is for each of the at least two different wavelengths, and further comprising:
(a) determining an effective color resulting from a combination of the at least two different wavelengths;
(b) determining whether the effective color comprises part of an undesirable color zone that is a proper subset of a color space comprising the at least two different wavelengths; and
(c) increasing or decreasing the absolute value of the voltage in response to whether the effective color comprises part of the undesirable color zone.

44. The method of claim 43 wherein when the effective color is outside of the undesirable color zone, the voltage is increased to lighten the switching material.

45. The method of claim 43 or 44 wherein when the effective color is within the undesirable color zone, the voltage is decreased to darken the switching material.

46. The method of any one of claims 43 to 45 wherein the at least two different wavelengths are wavelengths corresponding to blue light and green light.

47. The method of any one of claims 43 to 46 further comprising measuring an operating temperature of the switching material, and determining whether the effective color is within the undesirable color zone using the operating temperature.

48. The method of any one of claims 43 to 47 further comprising:
(a) measuring the intensity of the at least one wavelength of light that has not passed through the switching material;
(b) determining what percentage of the at least one wavelength of light is transmitted through the substrate and the switching material; and
(c) using the percentage of the at least one wavelength of light that is transmitted through the substrate and the switching material to determine the effective color.

49. The method of claim 39 wherein the absolute value of the voltage is increased to increase the transmittance of the switching material and the absolute value of the voltage is decreased to decrease the transmittance of the switching material.

50. The method of claim 39 further comprising:
(a) transitioning the switching material from a first transmittance to an intermediate transmittance that is between a maximum and minimum transmittance of the switching material; and
(b) maintaining the switching material at approximately the intermediate transmittance for a time period.

51. The method of claim 50 wherein the first transmittance is the maximum or minimum transmittance of the switching material.

52. The method of claim 50 or 51 wherein a pulse width modulated signal having a duty cycle of less than 100% is applied to transition the switching material to and maintain the switching material at the intermediate transmittance.

53. The method of claim 50 or 51 wherein a pulse width modulated signal that transitions between a non-zero peak voltage when on and a non-zero off voltage when off is applied to the switching material.

54. The method of claim 50 or 51 wherein a first pulse width modulated signal is applied to the switching material to transition the switching material to the intermediate state and a second pulse width modulated signal is applied to the switching material to maintain the switching material at the intermediate state, wherein the first pulse width modulated signal has a duty cycle higher than that of the second pulse width modulated signal.

55. The method of any one of claims 50 to 54 further comprising:
(a) obtaining an intensity measurement from the interior light sensor of the at least one wavelength of light; and
(b) when the intensity of the at least one wavelength of light exceeds an upper intensity threshold, transitioning the switching material to a darker intermediate state and maintain the switching material at the darker intermediate state.

56. The method of claim 55 further comprising, when the intensity of the at least one wavelength of light is below a lower intensity threshold, transitioning the switching material to a lighter intermediate state and maintaining the switching material at the lighter intermediate state.

57. The method of any one of claims 50 to 56 wherein during the time period, the transmittance of the switching material is maintained at within 50% of the intermediate transmittance, 40% of the intermediate transmittance, 30% of the intermediate transmittance, 20% of the intermediate transmittance, or 10% of the intermediate transmittance.

58. A method for varying transmittance of a variable transmittance vehicle window comprising a switching material, the method comprising:
(a) transitioning the switching material from a first transmittance to an intermediate transmittance that is between a maximum and minimum transmittance of the switching material; and
(b) maintaining the switching material at approximately the intermediate transmittance for a time period.

59. The method of claim 58 wherein the first transmittance is the maximum or minimum transmittance of the switching material.

60. The method of claim 58 or 59 wherein a pulse width modulated signal having a duty cycle of less than 100% is applied to transition the switching material to and maintain the switching material at the intermediate transmittance.

61. The method of claim 58 or 59 wherein a pulse width modulated signal that transitions between a non-zero peak voltage when on and a non-zero off voltage when off is applied to the switching material.

62. The method of claim 58 or 59 wherein a first pulse width modulated signal is applied to the switching material to transition the switching material to the intermediate state and a second pulse width modulated signal is applied to the switching material to maintain the switching material at the intermediate state, wherein the first pulse width modulated signal has a duty cycle higher than that of the second pulse width modulated signal.

63. The method of any one of claims 58 to 62 further comprising:
(a) obtaining an intensity measurement from the interior light sensor of the at least one wavelength of light; and
(b) when the intensity of the at least one wavelength of light exceeds an upper intensity threshold, transitioning the switching material to a darker intermediate state and maintain the switching material at the darker intermediate state.

64. The method of claim 63 further comprising, when the intensity of the at least one wavelength of light is below a lower intensity threshold, transitioning the switching material to a lighter intermediate state and maintaining the switching material at the lighter intermediate state.

65. The method of any one of claims 58 to 64 wherein during the time period, the transmittance of the switching material is maintained at within 50% of the intermediate transmittance, 40% of the intermediate transmittance, 30% of the intermediate transmittance, 20% of the intermediate transmittance, or 10% of the intermediate transmittance.

66. The method of claim 58 further comprising:
(a) obtaining, on an interior of a vehicle comprising the window, an intensity measurement of at least one wavelength of light that has passed through the window, wherein the at least one wavelength of light is a proper subset of the visible spectrum; and
(b) in response to the intensity measurement, increasing or decreasing the absolute value of the voltage applied across the electrodes such that the transmittance of the switching material is increased or decreased.

67. The method of claim 66 wherein the at least one wavelength of light comprises a range of wavelengths, and wherein the intensity measurement of the range of wavelengths is a cumulative intensity of the range of wavelengths.

68. The method of claim 67 wherein the range of wavelengths is continuous.

69. The method of claim 66 or 67 wherein the range of wavelengths comprises less than approximately 10% of the visible light spectrum, less than approximately 20% of the visible light spectrum, less than approximately 30% of the visible light spectrum, less than approximately 40% of the visible light spectrum, less than approximately 50% of the visible light spectrum, less than approximately 60% of the visible light spectrum, less than approximately 70% of the visible light spectrum, less than approximately 80% of the visible light spectrum, or less than approximately 90% of the visible light spectrum.

70. The method of any one of claims 66 to 69 wherein the at least one wavelength of light comprises at least two different wavelengths, wherein the intensity measurement is for each of the at least two different wavelengths, and further comprising:
(a) determining an effective color resulting from a combination of the at least two different wavelengths;
(b) determining whether the effective color comprises part of an undesirable color zone that is a proper subset of a color space comprising the at least two different wavelengths; and
(c) increasing or decreasing the absolute value of the voltage in response to whether the effective color comprises part of the undesirable color zone.

71. The method of claim 70 wherein when the effective color is outside of the undesirable color zone, the voltage is increased to lighten the switching material.

72. The method of claim 70 or 71 wherein when the effective color is within the undesirable color zone, the voltage is decreased to darken the switching material.

73. The method of any one of claims 70 to 72 wherein the at least two different wavelengths are wavelengths corresponding to blue light and green light.

74. The method of any one of claims 70 to 73 further comprising measuring an operating temperature of the switching material, and determining whether the effective color is within the undesirable color zone using the operating temperature.

75. The method of any one of claims 70 to 74 further comprising:
(a) measuring the intensity of the at least one wavelength of light that has not passed through the switching material, and wherein the processor:
(b) determining what percentage of the at least one wavelength of light is transmitted through the substrate and the switching material; and
(c) using the percentage of the at least one wavelength of light that is transmitted through the substrate and the switching material to determine the effective color.

76. The method of claim 63 wherein the absolute value of the voltage is increased to increase the transmittance of the switching material and the absolute value of the voltage is decreased to decrease the transmittance of the switching material.

77. A non-transitory computer readable medium having stored thereon program code that is executable by a processor and that, when executed by the processor, causes the processor to perform the method of any one of claims 39 to 77.

78. A variable transmittance vehicle window substantially as herein described.
